(19) United States
(12) Patent Application Publication
(10) Pub. No.: US 2021/0319463 A1
(43) Pub. Date: Oct. 14, 2021

(54) CONSENSUS BUILDING SUPPORT DEVICE AND CONSENSUS BUILDING SUPPORT METHOD

(71) Applicant: Hitachi, Ltd., Tokyo (JP)

(72) Inventors: Misa Miyakoshi, Tokyo (JP); Yasuhiro Asa, Tokyo (JP)

(21) Appl. No.: 17/201,850

(22) Filed: Mar. 15, 2021

(30) Foreign Application Priority Data
Apr. 14, 2020 (JP) 2020-72508

(51) Int. Cl. G06Q 30/02; G06Q 10/06

(52) U.S. Cl. CPC G06Q 30/0203; G06Q 10/06393

(57) ABSTRACT

A consensus building support device includes: a processor configured to execute a program; and a storage device configured to store the program, wherein the processor is configured to execute: acquisition processing of acquiring, for each of a plurality of evaluation indices with which a measure draft is evaluated, a numerical value range that is set for the evaluation index by each of a plurality of users; identification processing of identifying an overlap range in which a plurality of numerical value ranges that are each the numerical value range acquired for each of the plurality of evaluation indices through the acquisition processing overlap; and output processing of outputting the overlap range identified through the identification processing.

### CLAIM OF PRIORITY

The present application claims priority from Japanese patent application JP 2020-72508 filed on Apr. 14, 2020, the content of which is hereby incorporated by reference into this application.

### BACKGROUND

This invention relates to a consensus building support device and a consensus building support method, which are configured to provide support in building a consensus on a draft for a measure.

In JP 2015-141524 A, there is disclosed a consensus building support device configured to provide support in building a consensus. This consensus building support device includes: an acquisition module, which includes at least one element, and is configured to acquire, for each of a plurality of candidates for an alternative plan that is a subject of consensus building, information about an element that has influenced an evaluation of the candidate; a calculation module configured to calculate, based on the evaluation of each of the plurality of candidates and the information about the element that has influenced, a degree of influence of each element on the evaluation; and a creation module configured to create a modified candidate by adding or removing an element that is selected based on the degree of influence of each element to or from one of the plurality of candidates.

In JP 2015-141524 A, however, there is no consideration about providing support in building a consensus in an overlapping range, which is an overlap between numerical value ranges specified by users. The consensus building support device of JP 2015-141524 A consequently presents an optimum measure draft by taking in an opinion of only a specific user in some cases.

### SUMMARY

An object of this invention is to provide support in building a consensus on a measure draft that takes opinions of participating users into consideration.

An aspect of the invention disclosed in this application is a consensus building support device, comprising: a processor configured to execute a program; and a storage device configured to store the program, wherein the processor is configured to execute: acquisition processing of acquiring, for each of a plurality of evaluation indices with which a measure draft is evaluated, a numerical value range that is set for the evaluation index by each of a plurality of users; identification processing of identifying an overlap range in which a plurality of numerical value ranges that are each the numerical value range acquired for each of the plurality of evaluation indices through the acquisition processing overlap; and output processing of outputting the overlap range identified through the identification processing.

According to the exemplary embodiment of this invention, support in building a consensus on a measure draft that takes opinions of participating users into consideration can be provided. Other objects, configurations, and effects than those described above are clarified by the following description of an embodiment.

### BRIEF DESCRIPTION OF THE DRAWINGS

FIG. 1 is an explanatory diagram for illustrating a system configuration example of a consensus building support system.

FIG. 2 is a block diagram illustrating a hardware configuration example of a computer.

FIG. 3 is an explanatory diagram for showing an example of the evaluation index value table.

FIG. 4 is an explanatory diagram for showing an example of the evaluation index value range table.

FIG. 5 is an explanatory diagram for showing an example of the measure candidate DB.

FIG. 6 is an explanatory diagram for showing an example of the correlation table.

FIG. 7 is an explanatory diagram for illustrating a data input example 1, which is an example of data input with the use of an input screen displayed on one of the terminals.

FIG. 8 is an explanatory diagram for illustrating a data input example 2, which is an example of data input with the use of the input screen displayed on the one of the terminals.

FIG. 9 is an explanatory diagram for illustrating a data input example 3, which is an example of data input with the use of the input screen displayed on the one of the terminals.

FIG. 10 is an explanatory diagram for illustrating a data input example 4, which is an example of data input with the use of the input screen displayed on the one of the terminals.

FIG. 11 is an explanatory diagram for illustrating an example of determination of consensus range/compromise range overlap, which is executed for each evaluation index by the consensus building support device.

FIG. 12 is an explanatory diagram for illustrating an overlap range that is an overlap between ranges of more than one evaluation index.

FIG. 13 is an explanatory diagram for illustrating a result display screen example 1, which is an example of a result display screen on one of the terminals.

FIG. 14 is an explanatory diagram for illustrating a result display screen example 2, which is an example of the result display screen on the one of the terminals.

FIG. 15 is an explanatory diagram for illustrating an example of a processing procedure of data input from the terminals to the consensus building support device.

FIG. 16 is a flow chart for illustrating a consensus building support processing procedure example 1, which is an example of a consensus building support processing procedure executed by the consensus building support device.

FIG. 17 is a flow chart for illustrating a consensus building support processing procedure example 1, which is an example of a consensus building support processing procedure executed by the consensus building support device.

FIG. 18 is an explanatory diagram for illustrating another display example 1, which is another example of display in the case in which the consensus range/compromise range tab is selected.

FIG. 19 is an explanatory diagram for illustrating another display example 2, which is still another example of display in the case in which the consensus range/compromise range tab is selected.

FIG. 20 is an explanatory diagram for illustrating another display example 3, which is yet still another example of display in the case in which the consensus range/compromise range tab is selected.

### DETAILED DESCRIPTION OF THE EMBODIMENTS

<System Configuration Example>

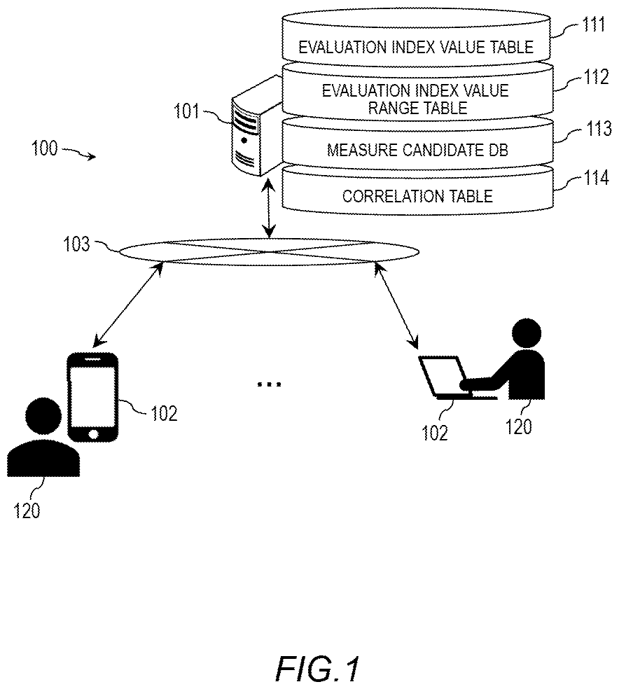

FIG. 1 is an explanatory diagram for illustrating a system configuration example of a consensus building support system. A consensus building system 100 includes a consensus building support device 101 functioning as a server and terminals 102 of a plurality of users 120. The consensus building support device 101 and the terminals 102 are coupled via a network 103, which is a local area network (LAN), a wide area network (WAN), or a similar network, in a manner that allows communication between the two.

The consensus building support device 101 is a computer configured to provide, when some measure is discussed in a region or a community that includes the plurality of users 120, support in building a consensus among the users 120. The plurality of users 120 are, for example, equals who are different from one another in position and attributes (examples: residents of a region, managers of businesses in a region, educators and others related to education, government officers, and landowners), but are not in a chain of command like the one to which a superior and a subordinate belong. However, the relationship among the plurality of users 120 is not limited to the relationship of equals.

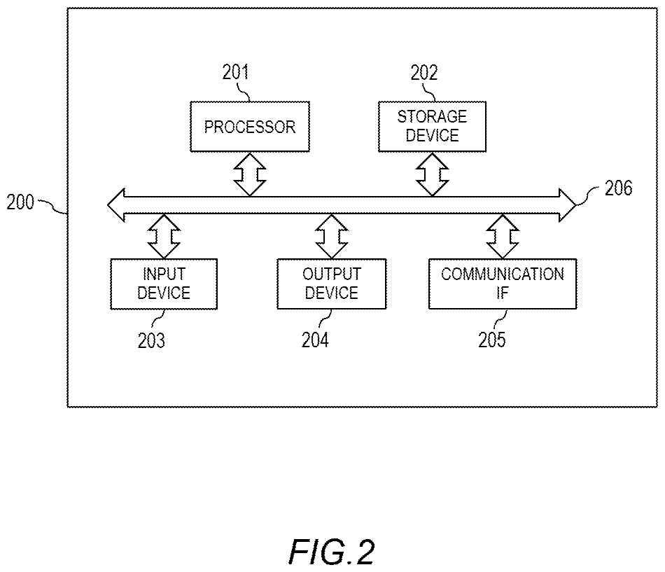

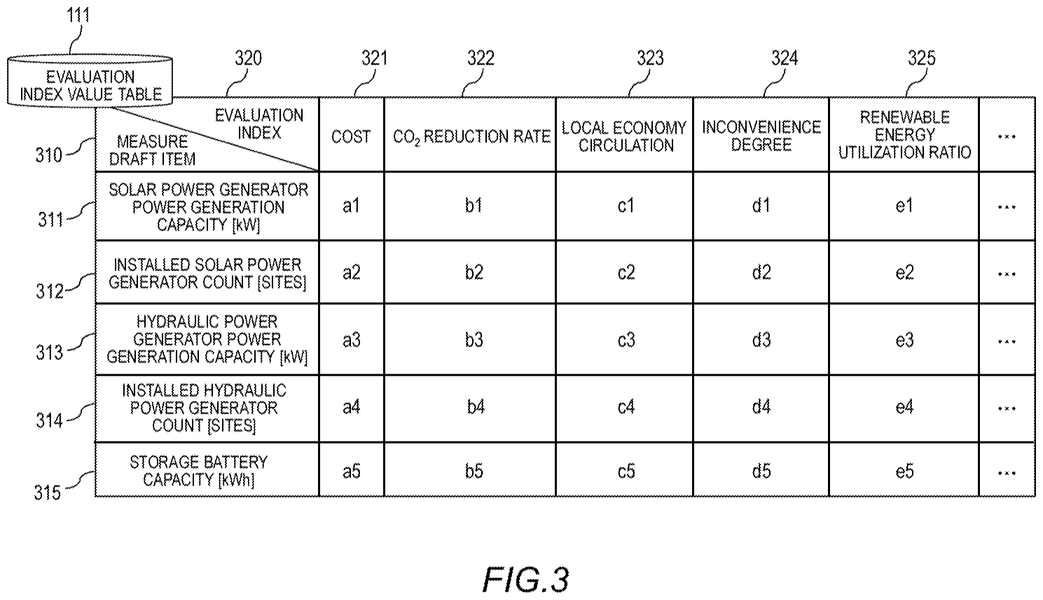

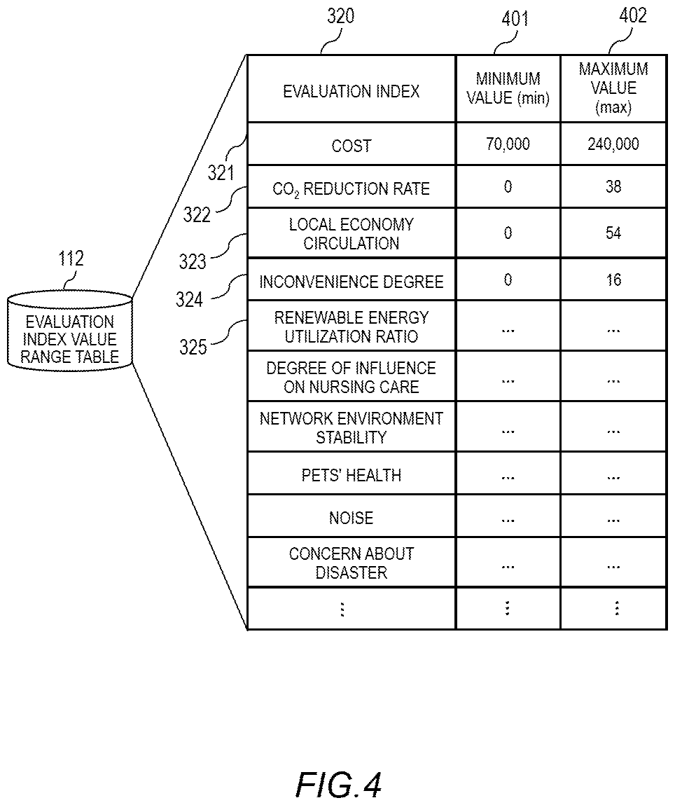

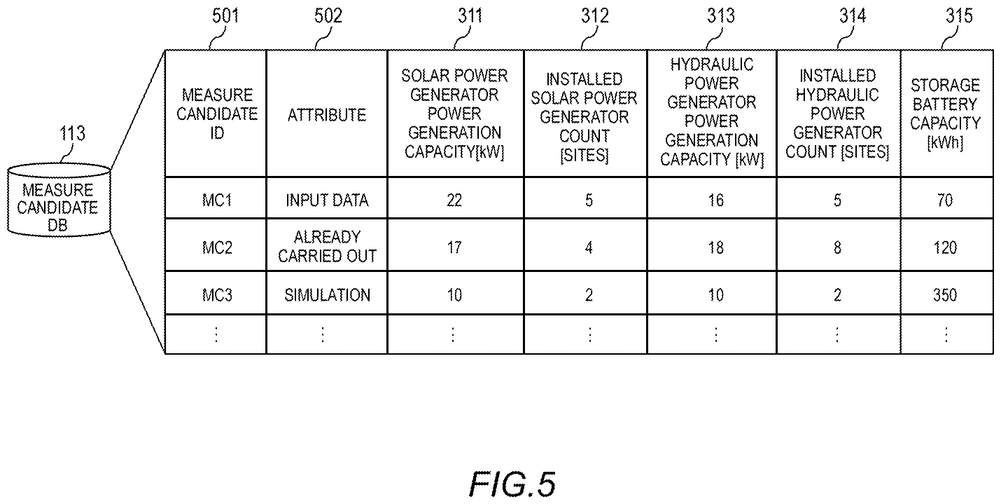

The consensus building support device 101 includes an evaluation index value table 111 (shown in FIG. 2), an evaluation index value range table 112 (shown in FIG. 3), a measure candidate database (DB) 113 (shown in FIG. 4), and a correlation table 114 (shown in FIG. 5). The evaluation index value table 111, the evaluation index value range table 112, the measure candidate DB 113, and the correlation table 114 may be stored on another computer coupled to the consensus building support device 101 via the network 103 in a manner that allows communication between the two.

The consensus building support system 100 of FIG. 1 is illustrated as a server-client system, but a stand-alone system obtained by removing the terminals 120 may be employed. In this case, data transmission from the terminals 102 to the consensus building support device 101 is replaced by data input to the consensus building support device 101 by the users 120, and data transmission from the consensus building support device 101 to the terminals 102 is replaced by display of data to be transmitted on a display by the consensus building support device 101, or output of the data to a printer by the consensus building support device 101 for the purpose of printing.

<Hardware Configuration Example of Computer (Consensus Building Support Device 101 and Terminals 102)>

FIG. 2 is a block diagram illustrating a hardware configuration example of a computer. The computer 200 includes a processor 201, a storage device 202, an input device 203, an output device 204, and a communication interface (communication IF) 205. The processor 201, the storage device 202, the input device 203, the output device 204, and the communication IF 205 are connected to one another by a bus 206. The processor 201 controls the computer 200. The processor 201 executes various programs. The storage device 202 serves as a work area of the processor 201. The storage device 202 is a non-transitory or temporary recording medium which stores the various programs and data. The storage device 202 can be, for example, a read-only memory (ROM), a random access memory (RAM), a hard disk drive (HDD), or a flash memory. The input device 203 inputs data. The input device 203 can be, for example, a keyboard, a mouse, a touch panel, a ten-key pad, a scanner or a microphone. The output device 204 outputs data. The output device 204 can be, for example, a display, a printer or a speaker. The communication IF 205 couples to a network to transmit and receive data.

The evaluation index value table 111, the evaluation index value range table 112, the measure candidate DB 113, and the correlation table 114 are stored in the storage device 202.

<Evaluation Index Value Table>

FIG. 3 is an explanatory diagram for showing an example of the evaluation index value table 111. The evaluation index value table 111 is a table configured to store an evaluation index value per unit quantity of a measure draft item 310. The measure draft item 310 is an element included in a measure draft. This example takes a measure draft about power storage/generation capacity as an example. This measure draft has, for example, a solar power generator power generation capacity 311, an installed solar power generator count 312, a hydraulic power generator power generation capacity 313, an installed hydraulic power generator count 314, and a storage battery capacity 315, as items each of which is the measure draft item 310.

An evaluation index 320 is an index for evaluating a draft. In this example, the evaluation index 320 includes, as indices for evaluating measure draft about power storage/generation capacity, a cost 321, a CO₂ reduction rate 322, local economy circulation 323, an inconvenience degree 324, a renewable energy utilization ratio 325, and others, for example.

The cost 321 indicates expense of that measure draft item 310. The CO₂ reduction rate 322 indicates a rate at which carbon dioxide is reduced when that measure draft item 310 is employed. The local economy circulation 323 is an index indicating how much local economic circulation is expected when that measure draft item 310 is employed (for example, a value obtained with a mathematical model in which a fee for installation work out of a cost of installing solar panels in the region is treated as a return for the region).

The inconvenience degree 324 is an index indicating how much inconvenience is incurred on living of the region's residents when that measure draft item 310 is employed (for example, an increase in resident tax). The renewable energy utilization ratio 325 indicates a ratio at which renewable energies are utilized in the region when that measure draft item 310 is employed.

Values (evaluation index values) a1 to a5, b1 to b5, c1 to c5, d1 to d5, e1 to e5, . . . of indices each of which is the evaluation index 320 for the measure draft item 310 are values per unit quantity. For instance, the value a1 of the cost 321 with respect to the solar power generator power generation capacity 311 is a value of the cost 321 (a purchase expense) per unit power generation capacity of a solar power generator. The value a2 of the cost 321 with respect to the installed solar power generator count 312 is a value of the cost 321 (an installation cost) required for installation per unit number of solar power generators.

The value a3 of the cost 321 with respect to the hydraulic power generator power generation capacity 313 is a value of the cost 321 (a purchase expense) per unit power generation capacity of a hydraulic power generator. The value a4 of the cost 321 with respect to the installed hydraulic power generator count 314 is a value of the cost 321 (an installation cost) required for installation per unit number of hydraulic power generators. The value a5 of the cost 321 with respect to the storage battery capacity 315 is a value of the cost 321 (a purchase expense) per unit capacity of a storage battery. The same applies to the values b1 to b5, c1 to c5, d1 to d5, and e1 to e5 of the CO₂ reduction rate 322, the local economy circulation 323, the inconvenience degree 324, and the renewable energy utilization ratio 325 with respect to each of the other measure draft items.

<Evaluation Index Value Range Table>

FIG. 4 is an explanatory diagram for showing an example of the evaluation index value range table 112. The evaluation index value range table 112 is a table configured to store, for each evaluation index 320, a minimum value 401 and a maximum value 402, which define a range of the evaluation index 320.

<Measure Candidate DB>

FIG. 5 is an explanatory diagram for showing an example of the measure candidate DB 113. The measure candidate DB 113 is a database configured to store measure candidates. The measure candidates include at least one out of a measure carried out in the past, a measure draft input in the past, and an existing measure draft obtained through simulation. The measure candidate DB 113 includes, as fields, a measure candidate ID 501, an attribute 502, the solar power generator power generation capacity 311, the installed solar power generator count 312, the hydraulic power generator power generation capacity 313, the installed hydraulic power generator count 314, and the storage battery capacity 315, and a set of values of the fields in the same row is an entry representing one measure candidate.

The measure candidate ID 501 is identification information for uniquely identifying a measure candidate of interest. The attribute 502 indicates the type of that measure candidate. For example, a value “input data” of the attribute 502 indicates that that measure candidate is a measure draft input in the past. A value “already carried out” indicates that that measure candidate is a measure carried out in the past. A value “simulation” indicates that that measure candidate is an existing measure draft obtained through simulation. The solar power generator power generation capacity 311, the installed solar power generator count 312, the hydraulic power generator power generation capacity 313, the installed hydraulic power generator count 314, and the storage battery capacity 315 indicate values (power generation capacities, installed generator counts, and a capacity) in the case of that measure candidate.

<Correlation Table>

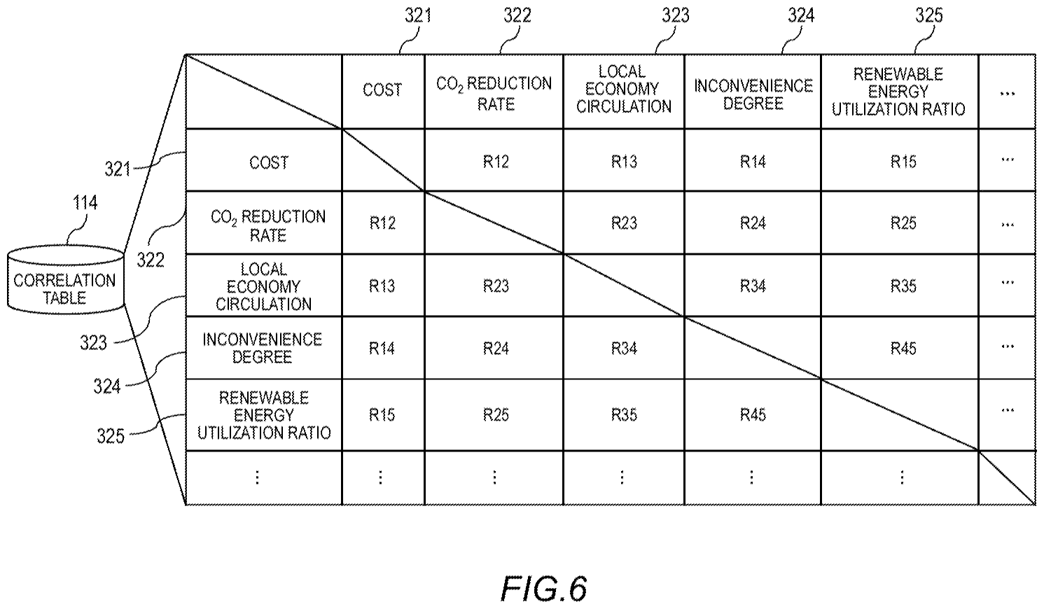

FIG. 6 is an explanatory diagram for showing an example of the correlation table 114. The correlation table 114 is a table configured to store a correlation coefficient between one evaluation index 320 and another evaluation index 320 that are two different evaluation indices, here, correlation coefficients R12 to R15, R23 to R25, R34, R35, R45, . . . (simply referred to as “correlation coefficients R” when discrimination from one another is not required). The correlation coefficients are calculated based on measure candidates stored in the measure candidate DB 113 and values in the evaluation index value table 111.

For instance, a column vector of the values of the cost 321 with respect to the solar power generator power generation capacity 311 can be obtained by multiplying the values of the solar power generator power generation capacity 311 in the measure candidate DB 113 by the value a1 in the evaluation index value table 111. Similarly, column vectors of the values of the cost 321 with respect to the installed solar power generator count 312, the hydraulic power generator power generation capacity 313, the installed hydraulic power generator count 314, and the storage battery capacity 315 can be obtained by multiplying by the corresponding values a2, a3, a4, and a5 of the cost 321.

Those column vectors are added for each element separately, to thereby obtain a column vector p=(p1, p2, . . . , pi, . . . , pn) (n is an integer equal to or more than 1) of the cost 321 with respect to all items that are each one measure draft item 310. In the same manner, a column vector q=(q1, q2, . . . , qi, . . . , qn) can be obtained for another evaluation index 320 different from the cost 321. A correlation coefficient r of P, which is one evaluation index 320, and Q, which is another evaluation index 320 different from P, is accordingly obtained by a known Expression (1).

$$R = \frac{\frac{1}{n} {\sum }_{i = 1}^{n} ( pi - pav ) ( qi - qav )}{\sqrt{\frac{1}{n} {\sum }_{i = 1}^{n} {( pi - pav )}^{2}} \sqrt{\frac{1}{n} {\sum }_{i = 1}^{n} {( qi - qav )}^{2}}} \qquad ( 1 )$$

In Expression (1), pay represents an average value of p1, p2, . . . pi, . . . , pn, and qav represents an average value of q1, q2, . . . , qi, . . . , qn. The correlation coefficients R are updated by the consensus building support device R or another computer each time a measure candidate is added to the measure candidate DB 113.

<Input Screen Example>

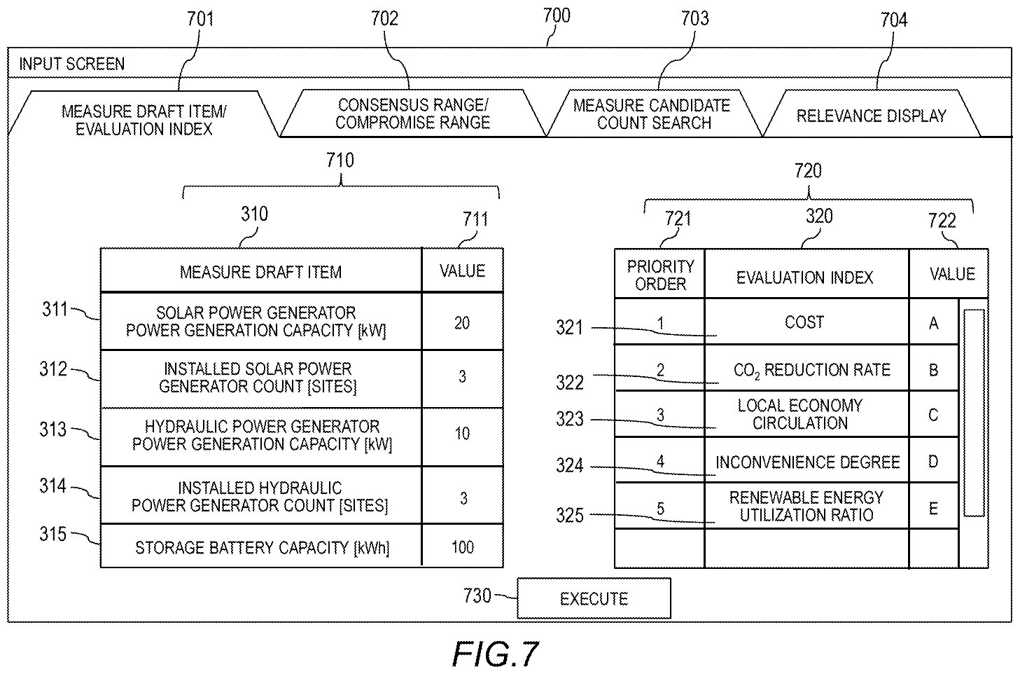

An example of data input using an input screen that is displayed on the terminals 102 is described next with reference to FIG. 7 to FIG. 10.

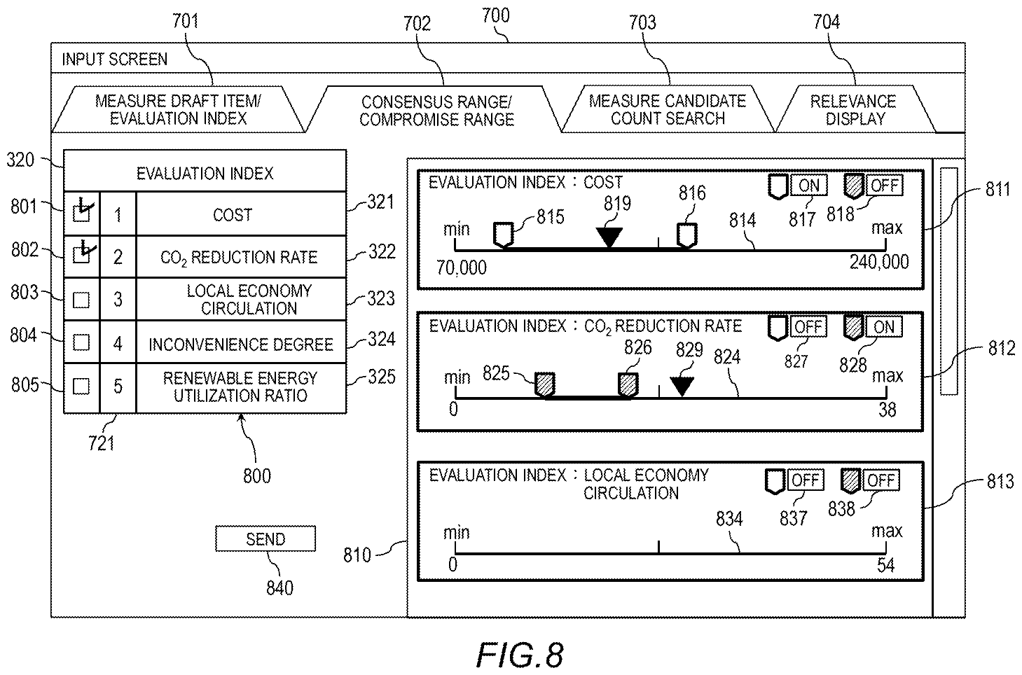

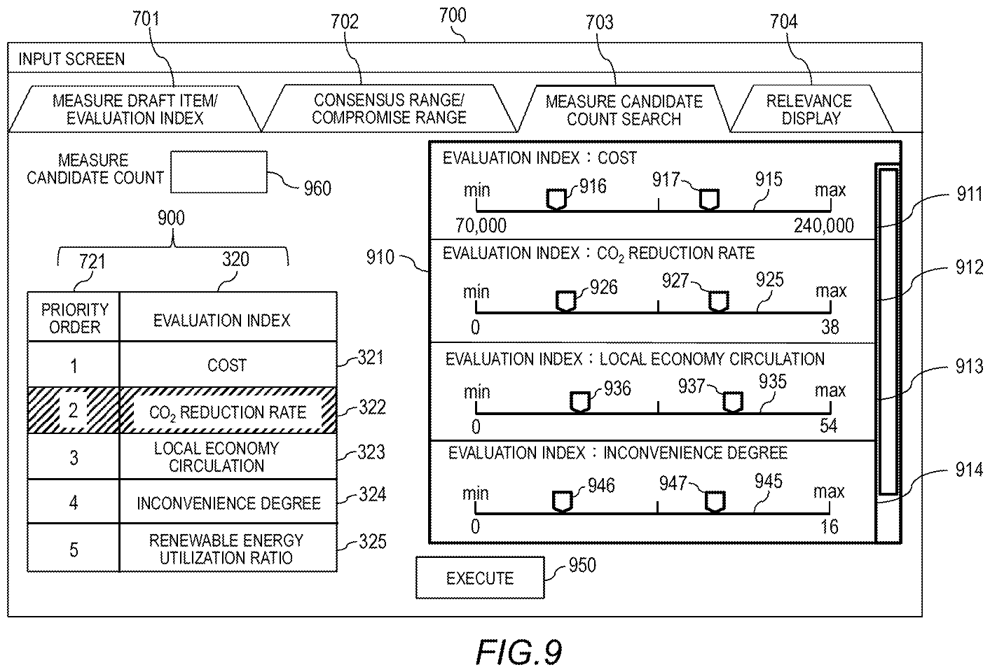

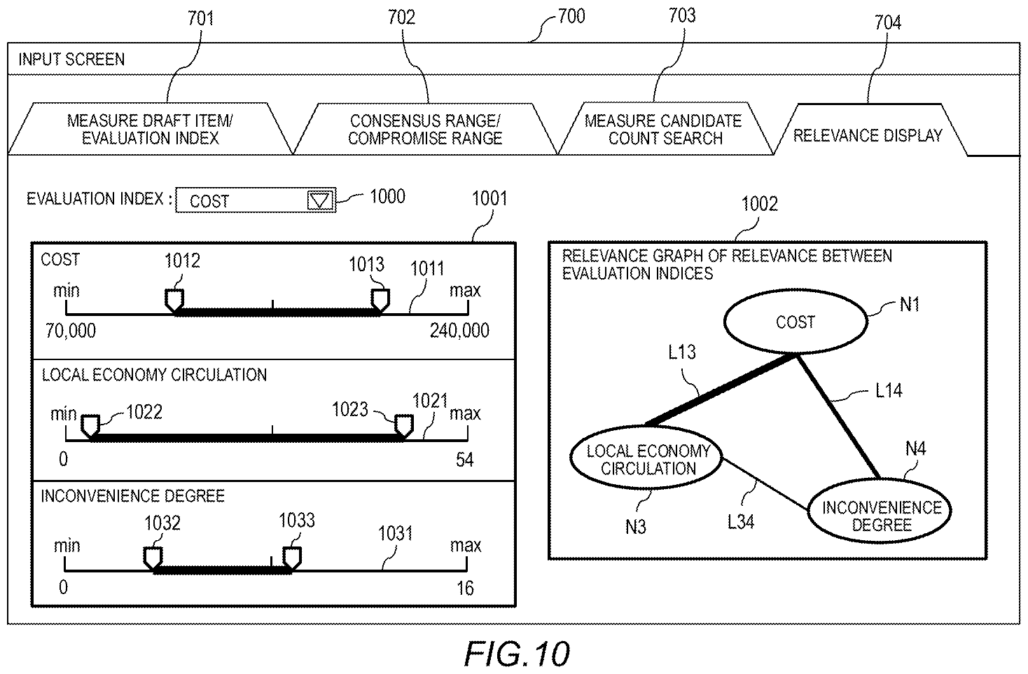

FIG. 7 is an explanatory diagram for illustrating a data input example 1, which is an example of data input with the use of an input screen displayed on one of the terminals 102. An input screen 700 includes a measure draft item/evaluation index tab 701, a consensus range/compromise range tab 702 (described later with reference to FIG. 8), a measure candidate count search tab 703 (described later with reference to FIG. 9), and a relevance display tab 704 (described later with reference to FIG. 10). The tabs 701 to 704 can be selected by operation of one of the users 120 who operates the one of the terminals 102.

The data input example 1 of FIG. 7 is an example of data input executed when the measure draft item/evaluation index tab 701 is selected. A measure draft item list 710, an evaluation index list 720, and an “execute” button 730 are displayed on the measure draft item/evaluation index tab 701. The measure draft item list 710 has, for each measure draft item 310, an input field 711 for inputting the value of the measure draft item 310. The value of the measure draft item 310 can be input in the input field 711. Not only a single numerical value but also a numerical value range, for example, “20-30” can be input in the input field 711.

The evaluation index list 720 has, for each evaluation index 320, a priority order 721 and a calculated value display field 722 for displaying a calculated value of the evaluation index 320. The priority order 721 is a place in the order of priority that is assigned to the evaluation index 320 by the one of the users 120. The priority order 721 of the evaluation index 320 is changeable by operation of the one of the users 120.

When the “execute” button 730 is pressed on the one of the terminals 102, the value of the measure draft item 310 that is input in the input field 711 is transmitted from the terminal to the consensus building support device 101. The consensus building support device 101 refers to the evaluation index value table 111, uses the received value of the measure draft item 310 to calculate the value of each evaluation index 320, here, values A to E, with respect to the measure draft item 310, and transmits the calculated values to the one of the terminals 102. The one of the terminals 102 displays the received values A to E, each of which is the value of one evaluation index 320, in the calculated value display field 722. This enables the one of the users 120 to check what value each evaluation index 320 takes with respect to the measure draft item 310 input by the one of the users 120.

FIG. 8 is an explanatory diagram for illustrating a data input example 2, which is an example of data input with the use of the input screen 700 displayed on the one of the terminals 120. The data input example 2 is an example of data input executed when the consensus range/compromise range tab 702 is selected. The consensus range is a range of values specified for each evaluation index 320 by the one of the users 120, and, when the specified range overlaps with a range of values specified for this evaluation index 320 by another of the users 120, is a range in which a consensus is built within the overlapping range. The compromise range is a range in which a compromise with another of the users 120 is required when the range of values specified for this evaluation index 320 by the one of the users 120 is not entirely included due to an overlap or non-overlap with a range of values specified for this evaluation index 320 by the another of the users 120.

An evaluation index selection list 800, an evaluation index value range setting area 810, and a “send” button 840 are displayed on the consensus range/compromise range tab 702. The evaluation index selection list 800 has, for each evaluation index 320, a check box, here, check boxes 801 to 805. In the check boxes 801 to 805, a check mark (noted by “✓” in FIG. 8) can be input and an input check mark can be removed by operation of the one of the users 120. In FIG. 8, check marks are input in the check box 801 of the cost 321 and the check box 802 of the CO₂ reduction rate 322.

The evaluation index value range setting area 810 has, for each evaluation index 320, a range setting graph with which a numerical value range can be specified, here, range setting graphs 811 to 813. The range setting graph 811 is a graph with which a range of the cost 321 can be set. The range setting graph 812 is a graph with which a range of the CO₂ reduction rate 322 can be set. The range setting graph 813 is a graph with which a range of the local economy circulation 323 can be set.

Numerical value axes 814, 824, and 834 are displayed in the range setting graphs 811, 812, and 813, respectively. On each of the numerical value axes 814, 824, and 834, “min” and “max” at two ends of the axis indicate the minimum value 401 and maximum value 402 of that evaluation index 320. Of the range setting graphs 811 to 813, the range setting graphs 811 and 812 are each a graph for the evaluation index 320 that is check-marked on the evaluation index selection list 800 (the cost 321 and the CO₂ reduction rate 322), and sliders 815 and 816 movable on the numerical value axis 814 and sliders 825 and 826 movable on the numerical value axis 824 can be displayed on those graphs by operation of the one of the users 120.

First display switching buttons 817, 827, and 837 are buttons for switching between display and non-display of the sliders with which a consensus range can be specified. For instance, the press of the first display switching button 817 in an “OFF” state causes a switch to an “ON” state, in which the sliders 815 and 816 are displayed. When a second display switching button 818 is “ON” at this point, a switch from “ON” to “OFF” takes place.

The second display switching buttons 818, 828, and 838 are buttons for switching between display and non-display of the sliders with which a compromise range can be specified. For instance, the press of the second display switching button 828 in an “OFF” state causes a switch to an “ON” state, in which the sliders 825 and 826 are displayed. When the first display switching button 827 is “ON” at this point, a switch from “ON” to “OFF” takes place.

The local economy circulation 323 is not check-marked on the evaluation index selection list 800, and sliders are therefore not displayed in the range setting graph 813 with the press of any of the first display switching button 837 and the second display switching button 838.

When values of one evaluation index 320 are calculated and displayed on the measure draft item/evaluation index tab 701, the values of that evaluation index 320 may be displayed with a marker 819 or 829. This enables the one of the users 120 to use the marker 819 or 829 as a guide in specifying a range of values of the evaluation index 320.

The “send” button 840 is a button for transmitting, with the press of the button, data that indicates the range specified with the use of the sliders to the consensus building support device 101 from the one of the terminals 102. In the example of FIG. 8, a combination of a lower limit value indicated by the slider 815 and an upper limit value indicated by the slider 816 is transmitted as the consensus range of the cost 321, and a combination of a lower limit value indicated by the slider 825 and an upper limit value indicated by the slider 826 is transmitted as the consensus range of the CO₂ reduction rate 322.

FIG. 9 is an explanatory diagram for illustrating a data input example 3, which is an example of data input with the use of the input screen 700 displayed on the one of the terminals 120. The data input example 3 is an example of data input executed when measure candidate count search tab 703 is selected. The measure candidate count search tab 703 is a tool for the users 120 who do not know values to be set for limit values and lower limit values of a consensus range and a compromise range. An evaluation index priority order setting list 900, an evaluation index graph 910, an “execute” button 950, and a search result display field 960 are displayed on the measure draft count search tab 703.

The evaluation index priority order setting list 900 is a list on which the priority order 721 can be set for each evaluation index 320. Hatching represents a cursor and, in FIG. 9, the CO₂ reduction rage 322 placed the second highest in the priority order 721 is selected with the cursor. A record selected with the cursor can be switched with a record of another priority order 721 by operation of the one of the users 120.

The evaluation index graph 910 displays, for each evaluation index 320, a range specification graph, here, range specification graphs 911 to 914, with which a numerical value range can be specified in conjunction with the priority order 721. The range specification graphs 911, 912, 913, and 914 have numerical value axes 915, 925, 935, and 945, respectively. On each of the numerical value axes 915, 925, 935, and 945, “min” and “max” at two ends of the axis indicate the minimum value 401 and maximum value 402 of that evaluation index 320. Sliders 916, 917, 926, 927, 936, 937, 946, and 947 are user interfaces movable on the numerical axes 915, 925, 935, and 945 by operation of the one of the users 120.

The “execute” button 950 is a button for searching for the number of measure candidates. With the press of the “execute” button 950, the priority order 721 of each evaluation index 320 in the evaluation index priority order setting list 900, and a numerical value range specified for each evaluation index 320 in the evaluation index graph 910 with the use of the sliders 916 and 917, the sliders 926 and 927, the sliders 936 and 937, or the sliders 946 and 947 are transmitted to the consensus building support device 101 from the one of the terminals 102.

The consensus building support device 101 receives the priority order 721 of each evaluation index 320 and the numerical value range specified for each evaluation index 320 in the evaluation index graph 910 with the use of the sliders 916 and 917, the sliders 926 and 927, the sliders 936 and 937, or the sliders 946 and 947, and searches the measure candidate DB 113 to find out the number of measure candidates that fall within the numerical value range of the evaluation index placed the highest in the priority order 721. Specifically, for example, the consensus building support device 101 multiplies, for each measure candidate in the measure candidate DB 113, the values of the solar power generator power generation capacity 311, the installed solar power generator count 312, the hydraulic power generator power generation capacity 313, the installed hydraulic power generator count 314, and the storage battery capacity 315 by the values a1 to a5 of the cost 321 in the evaluation index value table 111, to thereby calculate a value of the cost 321, which is the evaluation index 320 placed the highest in the priority order 721.

For example, a value of the cost 321 of a measure candidate that has “MC1” as the measure candidate ID 501 in FIG. 5 is calculated by “22×a1+5×a2+16×a3+5×a4+70×a5.” The calculated value of the cost 321 is referred to as “calculated cost.”

The consensus building support device 101 next counts the number of calculated costs within the received numerical value range of the cost 321. When the result of the counting is more than 0, the consensus building support device 101 calculates the CO₂ reduction rate 322 placed the second highest in the priority order 721 for a measure candidate whose calculated cost is within the numerical value range of the cost 321.

Specifically, for example, the consensus building support device 101 multiplies, for each measure candidate whose calculated cost is within the numerical value range of the cost 321, the values of the solar power generator power generation capacity 311, the installed solar power generator count 312, the hydraulic power generator power generation capacity 313, the installed hydraulic power generator count 314, and the storage battery capacity 315 by the values b1 to b5 of the CO₂ reduction rate 322 in the evaluation index value table 111, to thereby calculate a value of the CO₂ reduction rate 322, which is the evaluation index 320 placed the second highest in the priority order 721.

The consensus building support device 101 next counts the number of calculated CO₂ reduction rates within the received numerical value range of the CO₂ reduction rate 322. When the result of the counting is more than 0, the consensus building support device 101 calculates the local economy circulation 323 placed the third highest in the priority order 721, for a measure candidate whose calculated CO₂ reduction rate is within the numerical value range of the CO₂ reduction rate 322. In this manner, execution of the search is continued down to the evaluation index 320 placed the lowest in the priority order 721, as long as the result of the counting is not 0.

The consensus building support device 101 then transmits a measure candidate count that is the final result of the counting to the one of the terminals 102 as a search result. The one of the terminals 102 displays the received search result in the search result display field 960. A switch between the priority order 721 of one evaluation index 320 and the priority order 721 of another evaluation index 320 changes the search result. Accordingly, the search can be executed preferentially for the evaluation index 320 that is given importance.

The one of the users 102 can thus check how many measure candidates are found in a numerical value range set by himself or herself for one evaluation index 320. Specifically, the one of the users 120 can check whether a numerical value range set by himself or herself for one evaluation index 320 is appropriate when the number of measure candidates within the numerical value range set by the one of the users for the evaluation index 320 is larger.

FIG. 10 is an explanatory diagram for illustrating a data input example 4, which is an example of data input with the use of the input screen 700 displayed on the one of the terminals 120. The data input example 4 is an example of data input executed when the relevance display tab 704 is selected. The relevance display tab 704 is a tool for, for example, the users 120 who do not know which evaluation index 320 has relevance to which evaluation index 320. An evaluation index selection field 1000, a relevant evaluation index list 1001, and a relevance graph 1002 are displayed on the relevance display tab 704.

The evaluation index selection filed 1000 is a user interface in which one evaluation index 320 can be selected with, for example, a pulldown menu. In FIG. 10, “cost” is selected as an example.

The relevant evaluation index list 1001 is an area for displaying a numerical value range of the evaluation index 320 selected in the evaluation index selection field 1000 (hereinafter referred to as “selected evaluation index 320”), and a numerical value range of another evaluation index 320 (in FIG. 10, “local economy circulation” and “inconvenience degree”) that has relevance to the selected evaluation index 320 (“cost” in FIG. 10). A numerical value axis 1011 and sliders 1012 and 1013 are displayed for the selected evaluation index 320. A numerical value axis and two sliders are displayed for each evaluation index that is the another evaluation index 320, here, a numerical value axis 1021 and sliders 1022 and 1023, and a numerical value axis 1031 and sliders 1032 and 1033.

The another evaluation index 320 may be the evaluation index 320 that has a value equal to or higher than a threshold value as a correlation coefficient R, which is a coefficient of correlation with the selected evaluation index 320 (or the absolute value of the correlation coefficient R), or may be the evaluation index 320 selected separately on a user interface (not shown) by the one of the users 120.)

Initial positions of the sliders 1012, 1013, 1022, 1023, 1032, and 1033 are set by the one of the users 120. When one of the sliders 1012, 1022, and 1032 (for example, the slider 1012) is moved on a corresponding numerical value axis, which is the numerical value axis 1011 in this example, by operation of the one of the users 120, the consensus building support device 101 calculates a movement amount and movement direction of each unmoved slider out of the sliders 1012, 1022, and 1032, based on an amount and direction of the movement, and on a correlation coefficient stored in the correlation table 114. In this example, movement amounts and movement directions of the sliders 1022 and 1032 are calculated based on the movement amount and movement direction of the slider 1012, a correlation coefficient R13 of correlation between the cost 321 and the local economy circulation 323, and a correlation coefficient R14 of correlation between the cost 321 and the inconvenience degree 324.

For example, when the correlation coefficient R13 equals 0, the slider 1022 moves by a movement amount based on the movement amount of the slider 1012, in the same movement direction as the movement direction of the slider 1012. When the correlation coefficient R13 takes a value expressed by “0<R13≤1,” the slider 1022 moves by a movement amount based on the movement amount of the slider 1012 and on the correlation coefficient R13, in the same movement direction as the movement direction of the slider 1012. Specifically, a larger movement amount is set when the correlation coefficient R13 is larger. When the correlation coefficient R13 takes a value expressed by “−1<R13≤0,” the slider 1022 moves by a movement amount based on the movement amount of the slider 1012 and on the correlation coefficient R13, in a movement direction reverse to the movement direction of the slider 1012. Specifically, a larger amount of movement in the reverse direction is set when the correlation coefficient R13 is smaller.

The same applies to a case in which one of the sliders 1013, 1023, and 1033 is moved by operation of the one of the users 120. The calculation of the movement amount and the movement direction is executed by the consensus building support device 101 in the description given above, but may be executed by the one of the terminals 102. In this case, when the selected evaluation index 320 (the cost 321) is selected, the one of the terminals 102 calculates the movement amount and the movement direction by acquiring a correlation coefficient (the correlation coefficients R13 and R14) of correlation between the selected evaluation index 320 (the cost 321) and the another evaluation index 320 (the local economy circulation 323 and the inconvenience degree 324) from the correlation table 114 via the consensus building support device 101.

The relevance graph 1002 is an undirected graph indicating relevance between the selected evaluation index 320 and another evaluation index 320 on the relevant evaluation index list 1001. A node Ni represents the cost 321, which is the selected evaluation index 320, and nodes N3 and N4 represent the local economy circulation 323 and the inconvenience degree 324, respectively, which are each another evaluation index 320. A link L13 indicates relevance between the cost 321 and the local economy circulation 323. A link L4 indicates relevance between the cost 321 and the inconvenience degree 324. A link L34 indicates relevance between the local economy circulation 323 and the inconvenience degree 324.

Thicknesses of the link L13, the link L14, and the link L34 are in proportion to the magnitudes of the absolute values of the correlation coefficient R13, the correlation coefficient R14, and a correlation coefficient R34, respectively. Whether the correlation coefficients R13, R14, and R34 are positive or negative may be discriminated by, for example, colors of the link L13, the link L14, and the link L34.

The relevance graph 1002 enables the one of the users 120 to find out which evaluation index 320 has relevance to which evaluation index 320 to what degree. For instance, when the correlation coefficient R14 of correlation between the cost 321 and the inconvenience degree 324 indicates a negative correlation, the one of the users 120 can know that a drop of the inconvenience degree 324 (an increase in convenience) increases the cost 321.

<Example of Determination of Consensus Range/Compromise Range Overlap for Each Evaluation Index 320>

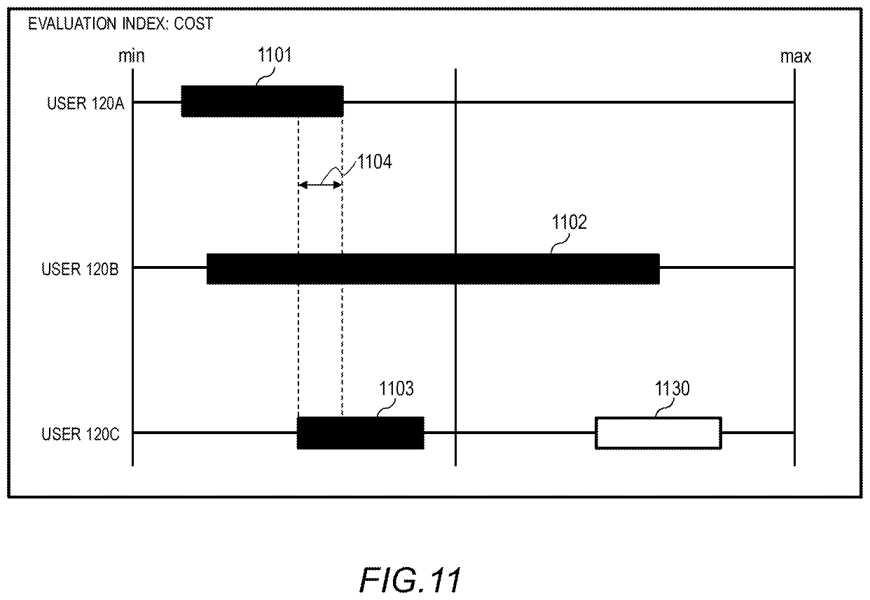

FIG. 11 is an explanatory diagram for illustrating an example of determination of consensus range/compromise range overlap, which is executed for each evaluation index 320 by the consensus building support device 101. In FIG. 11, the evaluation index 320 is the cost 321, three users, namely, a user 120A, a user 120B, and a user 120C specify consensus ranges 1101 to 1103, and an overlap range 1104 of the cost 321 is illustrated as a range in which the consensus ranges 1101 to 1103 overlap. The number of users is three in FIG. 11, but may be two, or four or more. The example uses the cost 321 but the same description applies to another evaluation index. Of the consensus ranges 1101 to 1103 used in the example, at least one may be replaced with a compromise range.

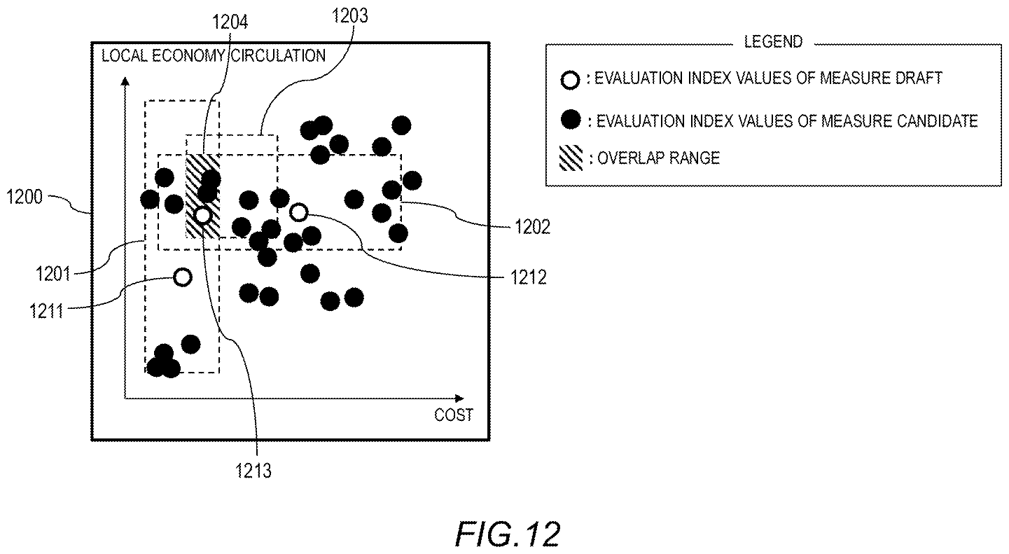

FIG. 12 is an explanatory diagram for illustrating an overlap range that is an overlap between ranges of more than one evaluation index 320. In FIG. 12, three users, namely, the users 120A to 120C specify consensus ranges 1201 to 1203 for one evaluation index 320 and another evaluation index 320, namely, the cost 321 and the local economy circulation 323, and an overlap range in which the consensus ranges 1201 to 1203 overlap is illustrated in a two-dimensional evaluation index graph 1200. White circles 1211 to 1213 of FIG. 12 are each a combination of the value A of one evaluation index 320 and the value C of the another evaluation index 320 that are displayed in the calculated value display field 722 for displaying a calculated value of each evaluation index 320 in the evaluation index list 730 for each of the users 120A to 120C. Black circles of FIG. 12 are each a combination of the value A of one evaluation index 320 and the value C of the another evaluation index 320 that are acquired on a measure candidate-by-measure candidate basis.

The value A of one evaluation index 320 (the cost 321) that is acquired on a measure candidate-by-measure candidate basis is calculated by multiplying the values of the solar power generator power generation capacity 311, the installed solar power generator count 312, the hydraulic power generator power generation capacity 313, the installed hydraulic power generator count 314, and the storage battery capacity 315 in the measure candidate DB 113 by the values a1 to a5 of the cost 321 in the evaluation index value table 111. The value C of the another evaluation index 320 (the local economy circulation 323) that is obtained on a measure candidate-by-measure candidate basis is calculated in a similar manner. The consensus building support device 101 may use the attribute 502 to filter measure candidates to be associated with the black circles.

In FIG. 12, the number of users is three but may be two, or four or more. The cost 321 and the local economy circulation 323 are taken as an example of one evaluation index 320 and another evaluation index 320, but a different combination of one evaluation index 320 and another evaluation index 320 may be employed. A combination of three or more evaluation indices that are each one evaluation index 320 may also be employed. In other words, the two-dimensional evaluation index graph 1200 may be replaced with a three- or higher dimensional graph.

<Result Display Example>

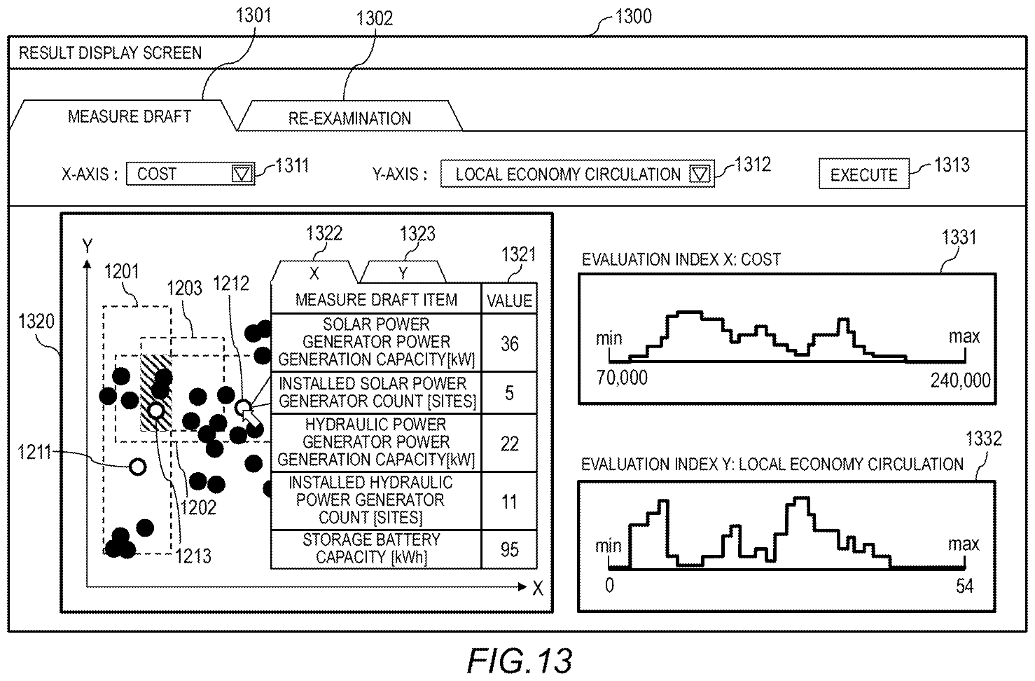

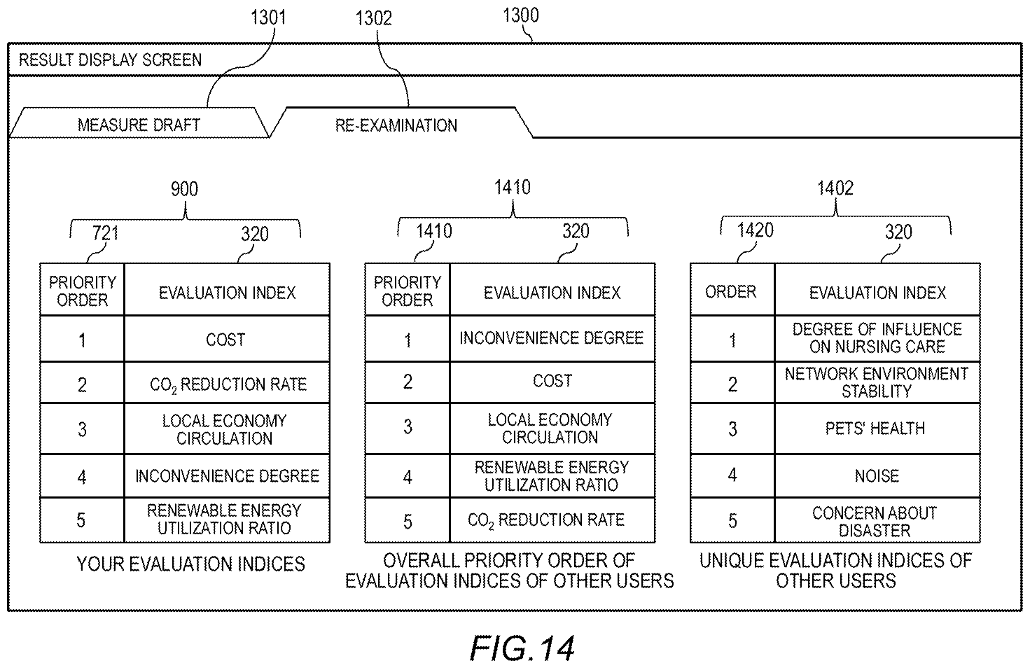

FIG. 13 is an explanatory diagram for illustrating a result display screen example 1, which is an example of a result display screen on one of the terminals 102. A result display screen 1300 includes a measure draft tab 1301 and a re-examination tab 1302 (described later with reference to FIG. 14). The measure draft tab 1301 and the re-examination tab 1302 can be selected by operation of one of the users 120 who operates the one of the terminals 102.

The result display screen example 1 of FIG. 13 is an example of the result display screen displayed when the measure draft tab 1301 is selected. An X-axis selection field 1311, a Y-axis selection field 1312, an “execute” button 1313, a two-dimensional evaluation index graph 1320, an X-axis evaluation index histogram 1331, and a Y-axis evaluation index histogram 1332 are displayed on the measure draft tab 1301.

The X-axis selection field 1311 is a user interface in which the evaluation index 320 to be plotted on an X-axis of the two-dimensional evaluation index graph 1320 can be selected with, for example, a pulldown menu. In FIG. 13, “cost” is selected as an example. The Y-axis selection field 1312 is a user interface in which the evaluation index 320 to be plotted on a Y-axis of the two-dimensional evaluation index graph 1320 can be selected with, for example, a pulldown menu. In FIG. 13, “local economy circulation” is selected as an example. The “execute” button 1311 is a user interface for displaying, when pressed, the two-dimensional evaluation index graph 1320, the X-axis evaluation index histogram 1331, and the Y-axis evaluation index histogram 1332.

The two-dimensional evaluation index graph 1320 is a graph formed from a coordinate space that is set along the X-axis and the Y-axis. The X-axis is a numerical value axis on which a value of the evaluation index 320 selected in the X-axis selection field 1311 (the X-axis evaluation index 320) is indicated. The Y-axis is a numerical value axis on which a value of the evaluation index 320 selected in the Y-axis selection field 1312 (the Y-axis evaluation index 320) is indicated. In FIG. 13, the X-axis evaluation index 320 is the cost 321, and the Y-axis evaluation index 320 is the local economy circulation 323. Information displayed in the two-dimensional evaluation index graph 1320 is accordingly the same as the information in the two-dimensional evaluation index graph 1200 of FIG. 12.

When the one of the users 120 specifies one of the white circles 1211 to 1213 (the white circle 1212 in FIG. 13), a measure draft item list 1321 identified by the value of the X-axis evaluation index 320 thereof and the value of the Y-axis evaluation index 320 thereof is displayed. The measure draft item list 1321 is the measure draft item list 710 input on the measure draft item/evaluation index tab 701 of FIG. 7 by the one of the users 120 or another of the users 120. The measure draft item list 1321 includes an X-tab 1322 and a Y-tab 1323, which can be selected by the one of the users 120. The X-tab 1322 displays the measure draft item list 710 of the X-axis evaluation index 320 (the cost 321), and the Y-tab 1323 displays the measure draft item list 710 of the Y-axis evaluation index 320.

Similarly, when one of the black circles is specified, the measure draft item list 1321 is displayed in association with the specified black circle. Values of the measure draft item list 1321 in this case are, for the X-axis evaluation index 320 (the cost 321), the values of the solar power generator power generation capacity 311, the installed solar power generator count 312, the hydraulic power generator power generation capacity 313, the installed hydraulic power generator count 314, and the storage battery capacity 315 in a measure candidate that satisfies values of the X-axis evaluation index 320 (the cost 321) and the values a1 to a5 of the cost 321 in the evaluation index value table 111.

Similarly, values of the measure draft item list 1321 in this case are, for the Y-axis evaluation index 320 (the local economy circulation 323), the values of the solar power generator power generation capacity 311, the installed solar power generator count 312, the hydraulic power generator power generation capacity 313, the installed hydraulic power generator count 314, and the storage battery capacity 315 in a measure candidate that satisfies values of the Y-axis evaluation index 320 (the local economy circulation 323) and the values c1 to c5 of the cost 321 in the evaluation index value table 111.

The X-axis evaluation index histogram 1331 indicates the number of cases corresponding to numerical values (or a given numerical value range) of the X-axis evaluation index 320 (the cost 321). The Y-axis evaluation index histogram 1332 indicates the number of cases corresponding to numerical values (or a given numerical value range) of the Y-axis evaluation index 320 (the local economy circulation 323).

Data to be used in the X-axis evaluation index histogram 1331 and the Y-axis evaluation index histogram 1332 may be values of the X-axis evaluation index 320 (the cost 321) and values of the Y-axis evaluation index 320 (the local economy circulation 323) of another of the users 120, or may be values of the X-axis evaluation index 320 (the cost 321) and values of the Y-axis evaluation index 320 (the local economy circulation 323) in a measure candidate, or may be both of the former two. In the case of a measure candidate, values of the X-axis evaluation index 320 (the cost 321) and values of the Y-axis evaluation index 320 (the local economy circulation 323) that are filtered by the attribute 502 may be used.

FIG. 14 is an explanatory diagram for illustrating a result display screen example 2, which is an example of the result display screen on the one of the terminals 102. The result display screen example 2 of FIG. 14 is an example of the result display screen displayed when the re-examination tab 1302 is selected. The evaluation index priority order setting list 900, an evaluation index overall priority order list 1401, and a unique evaluation index list 1402 are displayed on the re-examination tab 1302.

The evaluation index overall priority list 1401 is a list indicating, for each evaluation index 320, an overall place in the priority order 721 selected for the evaluation index 320 by other users 120. For example, the evaluation index 320 that is selected most is figured out for each place in order and is organized into a list. The unique evaluation index list 1402 is a list indicating a place in an order 1420 for each evaluation index 320 uniquely selected by other users 120, and the evaluation index 320 selected by fewer users 120 is placed higher in the order 1420. A priority order 1410 of the evaluation index overall priority order list 1401 and the order 1420 of the unique evaluation index list 1402 are determined by the consensus building support device 101, and the determined priority order 1410 and order 1420 are transmitted by the consensus building support device 101 to the one of the terminals 102.

<Data Input Processing Procedure>

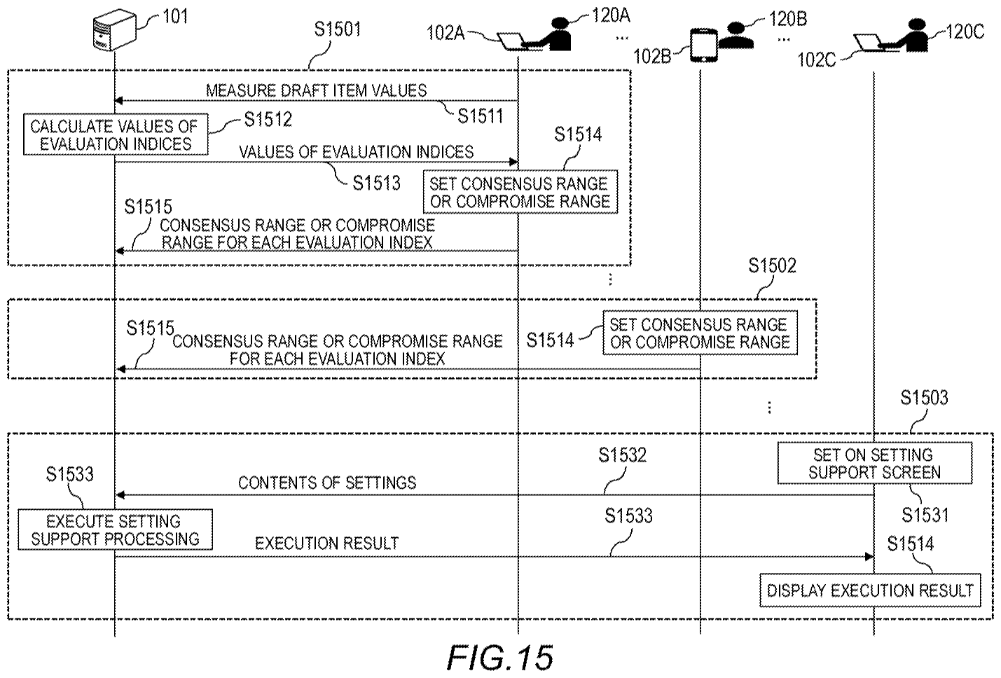

FIG. 15 is an explanatory diagram for illustrating an example of a processing procedure of data input from the terminals 102 to the consensus building support device 101. In the example of FIG. 15, the user 120A operating a terminal 102A is one of the users 120 who has a specific measure draft (a set of values of items that are each one measure draft item 310), the user 120B operating a terminal 102B is one of the users 120 who does not have a specific measure draft (a set of values of items that are each one measure draft item 310), but has one evaluation index 320 or more than one evaluation index 320 for a measure draft as well as a numerical value range of the evaluation index 320, and the user 120C operating a terminal 102C is one of the users 120 who does not have a specific measure draft and the evaluation index 320 for the measure draft.

Processing between the terminal 102A and the consensus building support device 101 is Step S1501, processing between the terminal 102B and the consensus building support device 101 is Step S1502, and processing between the terminal 102C and the consensus building support device 101 is Step S1503.

In Step S1501, the terminal 102A transmits the value of each measure draft item 310 to the consensus building support device 101 by operation of the user 120A (Step S1511). The consensus building support device 101 receives the value of each measure draft item 310 and calculates values of each evaluation index 320 (Step S1512). The consensus building support device 101 transmits the calculated values of each evaluation index 320 to the terminal 102A (Step S1513).

The terminal 102A receives the values of each evaluation index 320, and refers to the received values of each evaluation index 320 to set, for each evaluation index 320, a consensus range or a compromise range by operation of the user 120A (Step S1514). The terminal 102A transmits the consensus range or compromise range set for each evaluation index 320 to the consensus building support device 101 by operation of the user 120A (Step S1515). The transmitted consensus range or compromise range is kept on the consensus building support device 101.

The consensus building support device 101 can thus provide the user 120A who has a specific measure draft (a set of values of items that are each one measure draft item 310) with values of the corresponding evaluation index 320 by executing Step S1501. This enables the user 120A to refer to the values of the evaluation index 320, and accordingly facilitates the setting of a consensus range or a compromise range for the user 120A.

In Step S1502, the terminal 102B sets a consensus range or a compromise range for each evaluation index 320 by operation of the user 120B (Step S1514). The terminal 102B transmits the consensus range or compromise range set for each evaluation index 320 to the consensus building support device 101 by operation of the user 120B (Step S1515). The transmitted consensus range or compromise range is kept on the consensus building support device 101.

The user 120B who does not have a specific measure draft (a set of values of items that are each one measure draft item 310), but has one evaluation index 320 or more than one evaluation index 320 for a measure draft as well as a numerical value range can thus immediately provide a consensus range or a compromise range to the consensus building support device 101 through execution of Step S1502.

In Step S1503, the terminal 102C accesses the consensus building support device 101 by operation of the user 120C, to thereby display a setting support screen and set on the setting support screen (Step S1511). (Step S1531). The setting support screen is the measure candidate count search tab 703 illustrated in FIG. 9 and the relevance display tab 704 illustrated in FIG. 10.

The terminal 102C transmits contents of settings on the setting support screen by operation of the user 120C (Step S1532). The contents of settings are, for example, in the case of the measure candidate count search tab 703, the priority order 721 and values selected in the range specification graphs 911 to 914, and are transmitted to the consensus building support device 101 with the press of the “execute” button 950. In the case of the relevance display tab 704, the contents of settings are the evaluation index 320 selected in the evaluation index selection field 1000 (“cost” in FIG. 10), and the movement amount and movement direction of a slider moved by operation of the user 120C out of the sliders 1012, 1013, 1022, 1023, 1032, and 1033 of the relevant evaluation index list 1001.

The consensus building support device 101 receives the contents of settings, executes setting support processing (Step S1533), and transmits a result of the execution to the terminal 102C (Step S1533). The setting support processing (Step S1533) is, for example, in the case of the measure candidate count search tab 703, processing of searching for a measure candidate count based on the priority order 721 and the range specification graphs 911 to 914. The measure candidate count found out through the search is the result of the execution.

In the case of the relevance display tab 704, the setting support processing is processing of calculating movement amounts and movement directions of the sliders that have not been moved by operation of the user 120C out of the sliders 1012, 1013, 1022, 1023, 1032, and 1033 in the relevant evaluation index list 1001 as described above, and processing of extracting, from the correlation table 114, correlation coefficients R that are equal to or higher than a threshold value for the degree of correlation between the evaluation index 320 selected in the evaluation index selection field 1000 (the cost 321 in FIG. 10) and another evaluation index 320 relevant thereto.

The movement amounts and movement directions of the sliders that have not been moved, the extracted correlation coefficients R, and each relevant evaluation index 320 associated by one of the correlation coefficients R (the local economy circulation 323 and the inconvenience degree 324 in FIG. 10) are the results of the execution. The terminal 102C then displays the results of the execution from the consensus building support device 101 (Step S1514).

The consensus building support device 101 can thus provide the user 120C who does not have a specific measure draft and the evaluation index 320 for the measure draft with information useful in setting the value of each measure draft item 310 and a consensus range or a compromise range by executing Step S1503. This enables the user 120C to subsequently set the value of each measure draft item 310 and a consensus range or a compromise range through Step S1501 or Step S1502.

<Consensus Building Support Processing Procedure>

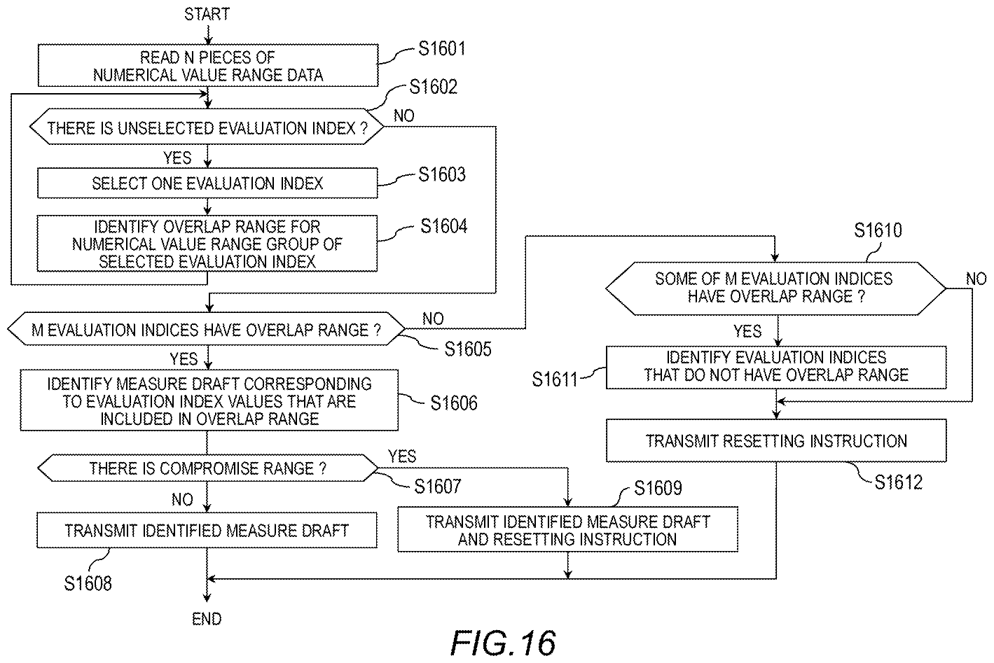

FIG. 16 is a flow chart for illustrating a consensus building support processing procedure example 1, which is an example of a consensus building support processing procedure executed by the consensus building support device 101. The consensus building support device 101 acquires N pieces of numerical value range data by reading out of the storage device (Step S1601). “N” is the number of users. The numerical value range data is a combination of an upper limit value and a lower limit value that define a consensus range or a compromise range about each evaluation index 320 out of a plurality of evaluation indices, for each of the users 120. The N pieces of numerical value range data are accumulated on the consensus building support device 101 through Step S1501 or Step S1502 illustrated in FIG. 15.

Each of the users 120 may select, as the plurality of evaluation indices which are each one evaluation index 320, evaluation indices common to all users 120, or evaluation indices common to only some of the users 120. There may be the evaluation index 320 that is selected by only one of the users 120, or there may be the evaluation index 320 that is selected by none of the users 120.

The consensus building support device 101 next determines whether there is the evaluation index 320 that has not been selected (Step S1602). When there is the evaluation index 320 that has not been selected (Step S1602: Yes), the consensus building support device 101 selects one evaluation index 320 that has not been selected (Step S1603). The consensus building support device 101 then acquires a numerical value range of each of the users 120 for the evaluation index 320 and, as illustrated in FIG. 11, identifies an overlap range in which the acquired numerical value ranges (N numerical value ranges at maximum) all overlap (Step S1604), before returning to Step S1602.

In the example of FIG. 11, the consensus ranges 1101 to 1103 of the users 120A to 120C all overlap in the overlap range 1104. However, if the user 120C sets a consensus range 1130 instead of the consensus range 1103, for example, the consensus range 1130 does not overlap with the consensus range 1101 of the user 120A. Consequently, an overlap range in which the consensus ranges 1101, 1102, and 1130 of the users 120A to 120C all overlap is not identified. A loop starting from a branch for “No” as the answer in Step S1602 and ending with Step S1604 is repeated M times. “M” is the number of types of all evaluation indices that are each one evaluation index 320 selected by at least one of the users 120.

When it is found in Step S1602 that no evaluation index 320 is an unselected evaluation index (Step S1602: No), the consensus building support device 101 determines whether M evaluation indices which are each one evaluation index 320 all have an overlap range (Step S1605). When M evaluation indices which are each one evaluation index 320 all have an overlap range (Step S1605: Yes), the consensus building support device 101 identifies, based on evaluation index values included in the overlap range, a measure draft that corresponds to the evaluation index values (Step S1606). The evaluation index values included in the overlap range are, for example, a combination of the value of the cost 321 and the value of the local economy circulation 323 that is identified by the white circle 1213 illustrated in FIG. 12.

For example, the consensus building support device 101 uses Y1, Y2, Y3, Y4, and Y5 as values of one evaluation index 320 and of four other evaluation indices (the cost 321, the CO₂ reduction rate 322, the local economy circulation 323, the inconvenience degree 324, and the renewable energy utilization ratio 325) that are included in the overlap range. In the evaluation index value table 111, each evaluation index 320 (the cost 321, the CO₂ reduction rate 322, the local economy circulation 323, the inconvenience degree 324, and the renewable energy utilization ratio 325) has one group of values out of a1 to a5, b1 to b5, c1 to c5, d1 to d5, and e1 to e5. Values X1, X2, X3, X4, and X5 of the solar power generator power generation capacity 311, the installed solar power generator count 312, the hydraulic power generator power generation capacity 313, the installed hydraulic power generator count 314, and the storage battery capacity 315, which are each one measure draft item 310, are accordingly calculated by the following simultaneous equations (2).

$$\begin{matrix}Y 1 = X 1 \times a 1 + X 2 \times a 2 + X 3 \times a 3 + X 4 \times a 4 + X 5 \times a 5 \\ Y 2 = X 1 \times b 1 + X 2 \times b 2 + X 3 \times b 3 + X 4 \times b 4 + X 5 \times b 5 \\ Y 3 = X 1 \times c 1 + X 2 \times c 2 + X 3 \times c 3 + X 4 \times c 4 + X 5 \times c 5 \\ Y 4 = X 1 \times d 1 + X 2 \times d 2 + X 3 \times d 3 + X 4 \times d 4 + X 5 \times d 5 \\ Y 5 = X 1 \times e 1 + X 2 \times e 2 + X 3 \times e 3 + X 4 \times e 4 + X 5 \times e 5\end{matrix} \} . \qquad ( 2 )$$

The consensus building support device 101 may select the values Y1, Y2, Y3, Y4, and Y5, which are each a value of one evaluation index 320 that is included in the overlap range, at random as long as the selected values are within the overlap range, and may use a value of each evaluation index 320 that is a lower limit value of the overlap range, or a value of each evaluation index 320 that is an upper limit value of the overlap range, or a value of each evaluation index 320 that is a median value of the overlap range, as Y1, Y2, Y3, Y4, and Y5.

The consensus building support device 101 may extract the values X1, X2, X3, X4, and X5 of the solar power generator power generation capacity 311, the installed solar power generator count 312, the hydraulic power generator power generation capacity 313, the installed hydraulic power generator count 314, and the storage battery capacity 315, which are each one measure draft item 310, from the measure candidate DB 113 to calculate the values Y1, Y2, Y3, Y4, and Y5, which are each a value of one evaluation index 320, by Expression (2) with the use of the values a1 to a5, the values b1 to b5, the values c1 to c5, the values d1 to d5, and the values e1 to e5, which are each a group of values of one evaluation index 320 (the cost 321, the CO₂ reduction rate 322, the local economy circulation 323, the inconvenience degree 324, or the renewable energy utilization ratio 325) in the evaluation index value table 111.

In this case, when the calculated Y 1, Y2, Y3, Y4, and Y5 are within the overlap range of evaluation indices that are each one evaluation index 320, the values X1, X2, X3, X4, and X5 of the solar power generator power generation capacity 311, the installed solar power generator count 312, the hydraulic power generator power generation capacity 313, the installed hydraulic power generator count 314, and the storage battery capacity 315, which are each one measure draft item 310, are each identified as the measure draft item 310.

When extracting the value of each measure draft item 310 from the measure candidate DB 113, the consensus building support device 101 may extract the value based on the attribute 502 or a combination of one attribute 502 and another attribute 502 or more than one other attribute 502 (only “input data”, only “already carried out”, only “simulation”, or a combination thereof). Whether the attribute 502 or a combination of one attribute 502 and another attribute 502 or more than one other attribute 502 is to be used is set in advance.

After Step S1606, the consensus building support device 101 determines whether the overlap range in which numerical value ranges of a plurality of evaluation indices that are each one evaluation index 320 overlap includes any numerical value range that is a compromise range (Step S1607). When no compromise range is included (Step S1607: No), the consensus building support device 101 transmits the values X1, X2, X3, X4, and X5, which are each the value of one measure draft item 310, as a measure draft to the terminals 102 of the users 120 (Step S1608), and ends the series of processing steps. When the measure draft is transmitted to the terminals 102 of the users 120, the measure draft tab 1301 illustrated in FIG. 13, for example, is displayed on the terminals 102 of the users 120.

When it is determined in Step S1607 that a compromise range is included (Step S1607: Yes), the consensus building support device 101 transmits the identified measure draft (the values X1, X2, X3, X4, and X5, which are each the value of one measure draft item 310) and a resetting instruction to the terminals 102 of the users 120 (Step S1609), and ends the series of processing steps. The resetting instruction in Step S1609 is an instruction with which the users 120 are prompted to reset the numerical value range of the evaluation index 320 that is a compromise range included in the overlap range. When the resetting instruction is transmitted to the terminals 102 of the users 120, the re-examination tab 1302 illustrated in FIG. 14, for example, is displayed on the terminals 102 of the users 120. The consensus building support device 101 may transmit the resetting instruction only to the terminals 102 of the users 120 who have set included compromise ranges.

When at least one of M evaluation indices that are each one evaluation index 320 does not have a numerical value range included in the overlap range in Step S1605 (Step S1605: No), the consensus building support device 101 determines whether some of the M evaluation indices that are each one evaluation index 320 have an overlap range (Step S1610). When some of the M evaluation indices that are each one evaluation index 320 (Step S1610: Yes), the consensus building support device 101 identifies the evaluation index 320 whose numerical range is not included in an overlap range (Step S1611), and proceeds to Step S1612.

When it is determined in Step S1610 that none of the M evaluation indices that are each one evaluation index 320 have an overlap range (Step S1610: No), on the other hand, the consensus building support device 101 proceeds to Step S1612.

In Step S1612, the consensus building support device 101 transmits a resetting instruction to the terminals 102 of the users 120 (Step S1612), and ends the series of processing steps. The resetting instruction in Step S1612 is an instruction with which the users 120 are prompted to reset the numerical value range of the evaluation index 320 that is not included in an overlap range. When the resetting instruction is transmitted to the terminals 102 of the users 120, the re-examination tab 1302 illustrated in FIG. 14, for example, is displayed on the terminals 102 of the users 120.

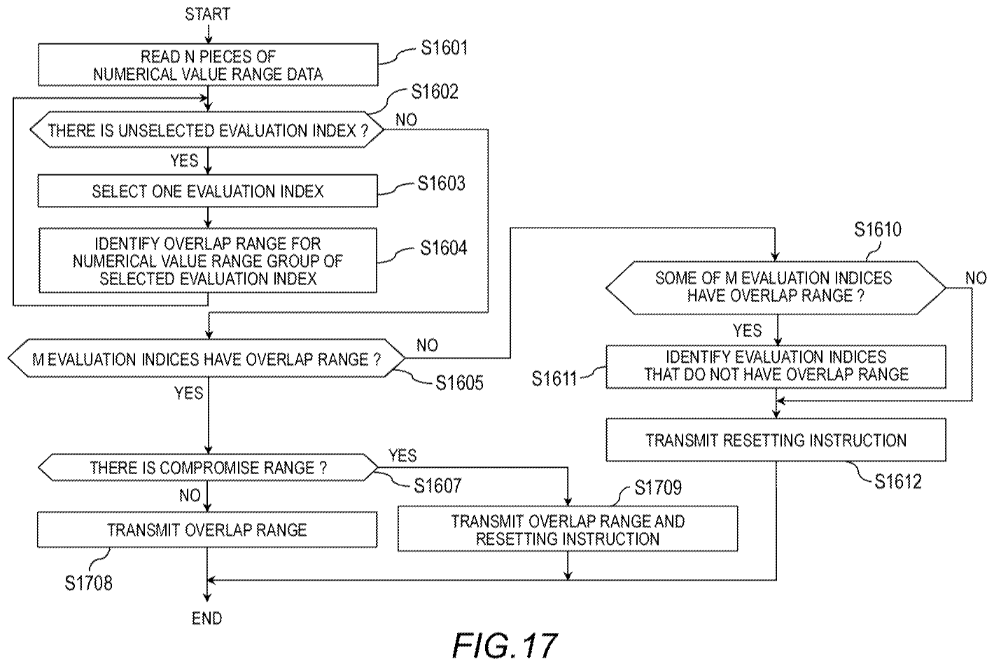

FIG. 17 is a flow chart for illustrating a consensus building support processing procedure example 1, which is an example of a consensus building support processing procedure executed by the consensus building support device 101. In the consensus building support processing procedure example 2, processing steps common to those in the consensus building support processing procedure example 1 of FIG. 16 are denoted by the same step numbers, and descriptions thereof are omitted.

When the M evaluation indices that are each one evaluation index 320 all have an overlap range in Step S1605 (Step S1605: Yes), the consensus building support device 101 determines, without identifying a measure draft that corresponds to evaluation index values included in the overlap range (Step S1606), whether the overlap range in which numerical value ranges of a plurality of evaluation indices that are each one evaluation index 320 overlap includes any numerical value range that is a compromise range (Step S1607). When no compromise range is included (Step S1607: No), the consensus building support device 101 transmits the overlap range to the terminals 102 of the users 120 (Step S1708), and ends the series of processing steps.

This enables the users 120 of the terminals 102 to check an overlap range for each evaluation index 320. With the overlap range known, the users 120 can search for the measure candidate count by setting the overlap range of each evaluation index 320 with the sliders 916 and 917, the sliders 926 and 927, the sliders 936 and 937, or the sliders 946 and 947.

When it is determined in Step S1607 that a compromise range is included (Step S1607: Yes), the consensus building support device 101 transmits the identified overlap range and a resetting instruction to the terminals 102 of the users 120 (Step S1709), and ends the series of processing steps. The resetting instruction in Step S1709 is an instruction with which the users 120 are prompted to reset the numerical value range of the evaluation index 320 that is a compromise range included in the overlap range. The consensus building support device 101 may transmit the resetting instruction only to the terminals 102 of the users 120 who have set included compromise ranges.

The terminals 102 may then transmit, by operation of the users 120, the execution instruction of Step S1606 of FIG. 16 for the overlap range of each evaluation index 320. This causes the consensus building support device 101 to execute Step S1606 to Step S1609 of FIG. 16.

### Other Examples

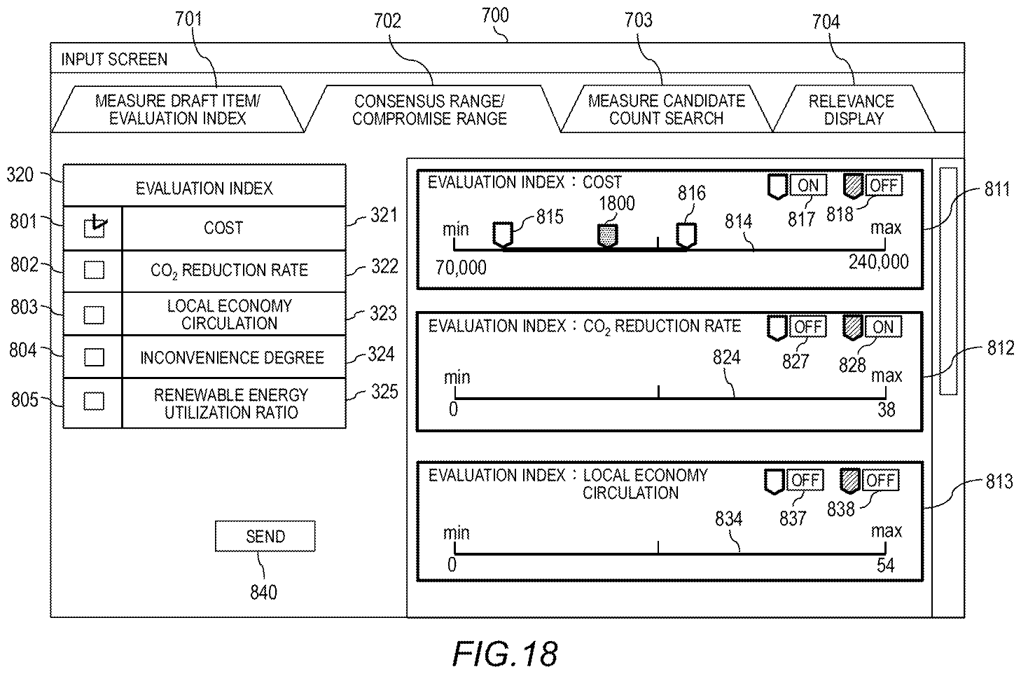

FIG. 18 is an explanatory diagram for illustrating another display example 1, which is another example of display in the case in which the consensus range/compromise range tab 702 is selected. In FIG. 18, a marker 1800 is displayed on the numerical value axis 814 of the range setting graph 811 of the cost 321. The marker 1800 marks a value acquired from the latest entry of the measure candidate DB 113 that has “already carried out” as the attribute 502 (for example, an entry having “MC2” as the measure candidate ID 501), and from the values of each evaluation index 320 in the evaluation index value table 111. The measure candidate may be the latest measure candidate carried out in the past by the one of the users 120, or may be the latest measure draft carried out in the past by another of the users 120.

Specifically, when a check mark is input in a check box (for example, the check box 801) on the one of the terminals 102, a code indicating the evaluation index 320 that is check-marked (the cost 321 in this case) is transmitted to the consensus building support device 101 from the one of the terminals 102. The consensus building support device 101 extracts a measure candidate that fits from the measure candidate DB 113, calculates an evaluation index value with the use of the values a1 to a5 of the cost 321 in the evaluation index value table 111, and returns the calculated evaluation index value to the one of the terminals 102. The one of the terminal 102 displays the marker 1800 that indicates the received evaluation index value on the numerical value axis 814. With the latest value of the evaluation index 320 displayed in the evaluation index value range setting area 810 in this manner, the one of the users 120 can set a consensus range or a compromise range by referring to the position of the marker 1800.

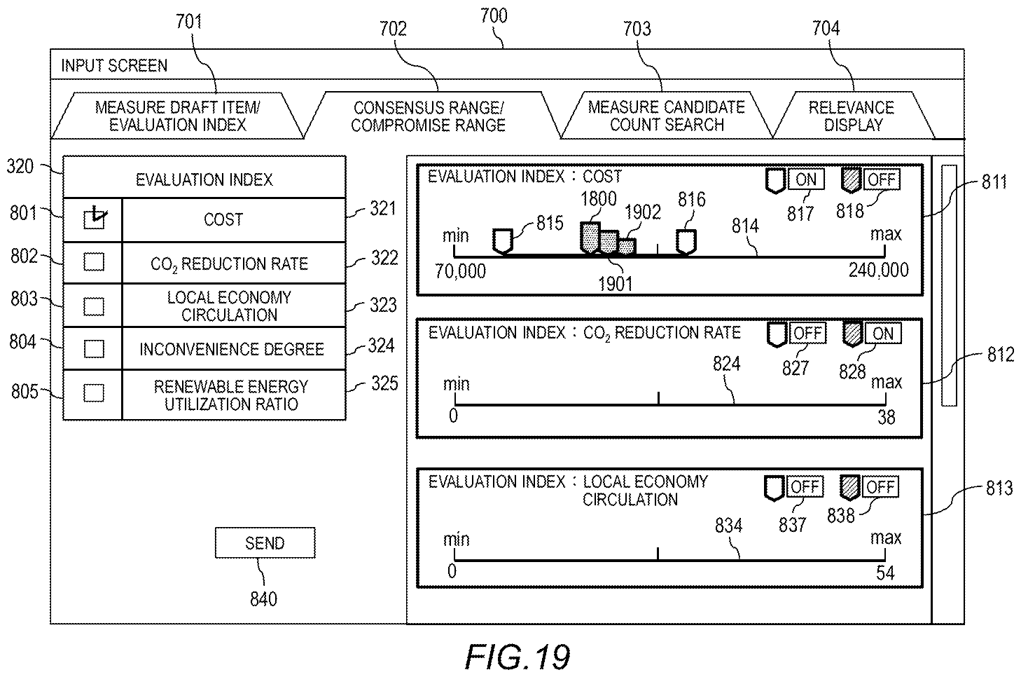

FIG. 19 is an explanatory diagram for illustrating another display example 2, which is still another example of display in the case in which the consensus range/compromise range tab 702 is selected. In FIG. 18, the marker 1800 is displayed with the use of the latest entry of a measure candidate that has “already carried out” as the attribute 502. As in FIG. 19, markers 1901 and 1902 may be displayed with the use of an entry of a measure candidate that precedes the latest measure candidate in time. The marker 1901 indicates, for example, an evaluation index value for a measure candidate that has been carried out one candidate prior to the latest measure candidate, and the marker 1902 indicates, for example, an evaluation index value for a measure candidate that has been carried out one candidate prior to the measure candidate of the evaluation index value indicated by the marker 1901. In this manner, the one of the users 120 can set a consensus range or a compromise range by referring to a history of past evaluation index values.

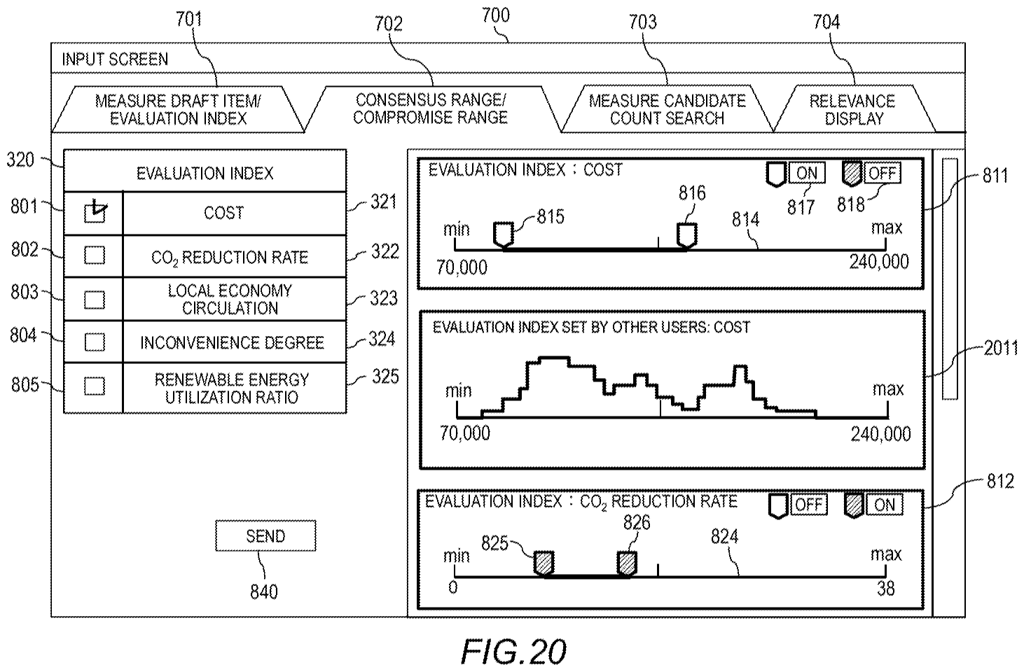

FIG. 20 is an explanatory diagram for illustrating another display example 3, which is yet still another example of display in the case in which the consensus range/compromise range tab 702 is selected. In FIG. 20, a check box (for example, the check box 801) is used to select one evaluation index 320 (the cost 321 in this case), and a histogram 2011 of the cost 321 set by other users 120 is displayed along with the range setting graph 811 of the selected evaluation index 320.

Specifically, when a check mark is input in a check box (for example, the check box 801) on the one of the terminals 102, a code indicating the evaluation index 320 that is check-marked (the cost 321 in this case) is transmitted to the consensus building support device 101 from the one of the terminals 102. The consensus building support device 101 aggregates numerical value ranges of the cost 321 that are transmitted from the terminals 102 of other users 120 through Step S1501 or S1502 of FIG. 15, and transmits the result of the aggregation to the one of the terminals 102 of the one of the users 120. The one of the terminals 102 displays the received result of the aggregation as the histogram 2011. The display of the histogram set by other users 120 thus enables the one of the users 120 to check in what range the numerical value ranges set for the evaluation index 320 by other users 120 overlap.

In this manner, the consensus building support device 101 described above can present a measure draft in which opinions of the plurality of users 120 are taken into consideration by acquiring consensus ranges or compromise ranges of a plurality of evaluation indices for a measure draft to be discussed, instead of presenting a measure draft that reflects opinions of only some specific users 120 as the optimum measure draft to the plurality of users 120. Specifically, instead of extracting majority opinion or a valuable evaluation index with the use of the consensus ranges or compromise ranges, for example, the consensus building support device 101 presents opinions of the users 120 in different positions, or processes the opinions into information easy to understand to other users 120 and presents the information, to thereby prompt the plurality of users 120 to evaluate a measure draft from various perspectives. The consensus building support device 101 described above can thus provide support in building a consensus on a measure draft that takes opinions of the participating users 120 into consideration.

The consensus building support device 101 described above may have the configurations described in items (1) to (14).

(1) There is provided the consensus building support device 101 including the processor 201 configured to execute a program and the storage device 202 configured to store the program, wherein the processor 201 is configured to execute: acquisition processing of acquiring, for each evaluation index 320 out of a plurality of evaluation indices used to evaluate a measure draft, a numerical value range set for the evaluation index 320 by each of the plurality of users 120; identification processing of identifying the overlap range 1104 in which a plurality of numerical value ranges acquired for each evaluation index 320 through the acquisition processing overlap; and output processing of outputting the overlap range 1104 identified through the identification processing.

(2) In the consensus building support device 101 according to the item (1) described above, the processor 201 is configured to, in the output processing, when the overlap range 1104 is not identified, output a resetting instruction for resetting the numerical value range.

(3) In the consensus building support device 101 according to the item (1) described above, the processor 201 is configured to, when the overlap range 1104 is identified for some of the plurality of evaluation indices, which are each one evaluation index 320, in the identification processing, identify other evaluation indices that are each the evaluation index 320 having a numerical value range that is outside the overlap range 1104, and the processor 201 is configured to output a resetting instruction for resetting numerical value ranges of the other evaluation indices that are each the evaluation index 320 having the numerical value range that is outside the overlap range 1104 in the output processing.

(4) In the consensus building support device 101 according to the item (2) described above, the processor 201 is configured to output, in the output processing, to each of the terminals 102 of the users 120, the priority order 721 of each evaluation index 320 among the plurality of evaluation indices that is set by other users 120, as the resetting instruction.

(5) In the consensus building support device 101 according to the item (1) described above, the plurality of numerical ranges include at least one of a consensus range, in which the numerical value range of one of the users 120 overlaps with the numerical value ranges of the other users 120 and the one of the users 120 consents within the overlap range 1104, or a compromise range, in which the numerical value range of the one of the users 120 is outside the numerical value ranges of the other users 120 and the one of the users 120 is required to compromise with the other users 120, and the processor 201 is configured to: execute determination processing of determining whether the plurality of numerical ranges include the compromise range; and output, when determining that no compromise range is included in the determination processing, the overlap range 1104 in the output processing.

(6) In the consensus building support device 101 according to the item (5) described above, the processor 201 is configured to, when determining that the plurality of numerical value ranges include the compromise range in the determination processing, output a resetting instruction for resetting numerical value ranges of a plurality of evaluation indices that are each one evaluation index 320 in the output processing.

(7) The consensus building support device 101 according to the item (1) described above has access to the evaluation index value table 111 configured to store values (a1 to a5, b1 to b5, c1 to c5, d1 to d5, and e1 to e5) of each evaluation index 320 out of the plurality of evaluation indices per unit quantity of each measure draft item 310 defining a measure draft, and the processor 201 is configured to, in the identification processing, calculate values (X1, X2, X3, X4, and X5) of measure draft items that are each one measure draft item 310 based on values (Y1, Y2, Y3, Y4, and Y5) included in the overlap range 1104 as values of the plurality of evaluation indices that are each one evaluation index 320, and on the values (a1 to a5, b1 to b5, c1 to c5, d1 to d5, and e1 to e5) of each evaluation index 320 out of the plurality of evaluation indices per unit quantity of each measure draft item 310, and identify the calculated values of the measure draft items that are each one measure draft item 310 as a measure draft.

(8) The consensus building support device 101 according to the item (7) described above has access to the measure candidate DB 113 configured to store the values (X1, X2, X3, X4, and X5) of the measure draft items as a measure candidate, and the processor 201 is configured to calculate, in the identification processing, the values (Y1, Y2, Y3, Y4, and Y5) of the plurality of evaluation indices that are each one evaluation index 320, based on the values (a1 to a5, b1 to b5, c1 to c5, d1 to d5, and e1 to e5) of each evaluation index 320 out of the plurality of evaluation indices per unit quantity of each measure draft item 310 and on the values (X1, X2, X3, X4, and X5) of the measure draft items that are each one measure draft item 310, and, when the calculated values (Y1, Y2, Y3, Y4, and Y5) of the plurality of evaluation indices that are each one evaluation index 320 are included in the overlap range 1104, identify the values (X1, X2, X3, X4, and X5) of the measure draft items that are each one measure draft item 310 as a measure draft.

(9) In the consensus building support device 101 according to the item (8) described above, the measure candidate DB 113 is configured store the value of each measure draft item 310 in association with the attribute 502 of a measure candidate, and the processor 201 is configured to calculate, in the identification processing, values of the plurality of evaluation indices that are each one evaluation index 320, based on the values of each evaluation index 320 out of the plurality of evaluation indices per unit quantity of each measure draft item 310, and on a value of each measure draft item 310 that is associated with a specific value of the attribute 502, and, when the calculated values of the plurality of evaluation indices that are each one evaluation index 320 are included in the overlap range 1104, identify the values of the measure draft items that are each one measure draft item 310 as a measure draft.

(10) In the consensus building support device 101 according to the item (9) described above, the specific value of the attribute 502 is information indicating that the value of the measure draft item 310 is input data that is input by another of the users 120 (“input data” of the attribute 502).

(11) In the consensus building support device 101 according to the item (9) described above, the specific value of the attribute 502 is information indicating that the value of the measure draft item 310 is a value in a measure carried out in the past (“already carried out” of the attribute 502).

(12) In the consensus building support device 101 according to the item (9) described above, the specific value of the attribute 502 is information indicating that the value of the measure draft item 310 is a value obtained through simulation (“simulation” of the attribute 502).

(13) The consensus building support device 101 according to the item (1) described above has access to: the evaluation index value table 111 configured to store values of each evaluation index 320 out of the plurality of evaluation indices per unit quantity of each measure draft item 310 defining a measure draft; and the measure candidate DB 113 configured to store values of measure draft items that are each one measure draft item 310 as a measure candidate, and the processor 201 is configured to acquire, in the acquisition processing, the priority order 721 set for each evaluation index 320 out of the plurality of evaluation indices by one of the users 120, and a numerical value range of each evaluation index 320 out of the plurality of evaluation indices, select one specific evaluation index 320 out of the plurality of evaluation indices that are each one evaluation index 320 in accordance with the priority order 721 that is set for each evaluation index 320 among the plurality of evaluation indices by the one of the users 120 and that is acquired through the acquisition processing, calculate, for each measure candidate, a value of the specific evaluation index 320 based on values of measure draft items that are each one measure draft item 310 and on values of each evaluation index 320 out of the plurality of evaluation indices per unit quantity of each measure draft item 310, execute search processing of searching for the number of measure candidates in which the calculated value is included in a numerical value range that is set for the specific evaluation index 320 by the one of the users 120, and output, in the output processing, a search result obtained through the search processing.

(14) The consensus building support device 101 according to the item (1) described above stores the correlation table 114 including the correlation coefficients R about correlation between different evaluation indices that are each one evaluation index 320, and the processor is configured to acquire, in the acquisition processing, a value of and a change amount of a first evaluation index 320, execute calculation processing of calculating a change amount of a second evaluation index 320, based on the value and change amount of the first evaluation index 320 that are acquired in the acquisition processing and on one of the correlation coefficients R that indicates a coefficient of correlation between the first evaluation index 320 and the second evaluation index 320 in the correlation table 114, and output, in the output processing, the change amount of the second evaluation index 320 that is calculated through the calculation processing.

It should be noted that this disclosure is not limited to the above-mentioned embodiments, and encompasses various modification examples and the equivalent configurations within the scope of the appended claims without departing from the gist of this disclosure. For example, the above-mentioned embodiments are described in detail for a better understanding of this disclosure, and this disclosure is not necessarily limited to what includes all the configurations that have been described. Further, a part of the configurations according to a given embodiment may be replaced by the configurations according to another embodiment. Further, the configurations according to another embodiment may be added to the configurations according to a given embodiment. Further, a part of the configurations according to each embodiment may be added to, deleted from, or replaced by another configuration.

Further, a part or entirety of the respective configurations, functions, processing modules, processing means, and the like that have been described may be implemented by hardware, for example, may be designed as an integrated circuit, or may be implemented by software by a processor interpreting and executing programs for implementing the respective functions.

The information on the programs, tables, files, and the like for implementing the respective functions can be stored in a storage device such as a memory, a hard disk drive, or a solid state drive (SSD) or a recording medium such as an IC card, an SD card, or a DVD.

Further, control lines and information lines that are assumed to be necessary for the sake of description are described, but not all the control lines and information lines that are necessary in terms of implementation are described. It may be considered that almost all the components are connected to one another in actuality.

What is claimed is:

1. A consensus building support device, comprising:
a processor configured to execute a program; and
a storage device configured to store the program,
wherein the processor is configured to execute:
acquisition processing of acquiring, for each of a plurality of evaluation indices with which a measure draft is evaluated, a numerical value range that is set for the evaluation index by each of a plurality of users;
identification processing of identifying an overlap range in which a plurality of numerical value ranges that are each the numerical value range acquired for each of the plurality of evaluation indices through the acquisition processing overlap; and
output processing of outputting the overlap range identified through the identification processing.

2. The consensus building support device according to claim 1, wherein the processor is configured to output, in the output processing, when the overlap range is not identified, a resetting instruction for resetting the numerical value range.

3. The consensus building support device according to claim 1,
wherein the processor is configured to identify, when an overlap range is identified with respect to some of the plurality of evaluation indices, rest of the plurality of evaluation indices, which are outside the overlap range, in the identification processing, and
wherein the processor is configured to output, in the output processing, a resetting instruction for resetting numerical value ranges of the rest of the plurality of evaluation indices.

4. The consensus building support device according to claim 2, wherein the processor is configured to output, in the output processing, to each of terminals of the plurality of users, a priority order set to each of the plurality of evaluation indices by other users out of the plurality of users, as the resetting instruction.

5. The consensus building support device according to claim 1,
wherein the plurality of numerical value ranges include at least one of a consensus range, in which the numerical value range of one of the plurality of users overlaps with the numerical value ranges of other users out of the plurality of users, and the one of the plurality of users consents within the overlap range, or a compromise range, in which the numerical value range of the one of the plurality of users is outside the numerical value ranges of other users out of the plurality of users, and the one of the plurality of users is required to compromise with the other users, and
wherein the processor is configured to:
execute determination processing of determining whether the plurality of numerical value ranges include the compromise range; and
output, when determining that no compromise range is included through the determination processing, the overlap range in the output processing.

6. The consensus building support device according to claim 5, wherein the processor is configured to output, when determining that the compromise range is included through the determination processing, a resetting instruction for resetting the numerical value ranges of the plurality of evaluation indices in the output processing.

7. The consensus building support device according to claim 1,
wherein the consensus building support device has access to an evaluation index value table configured to store values of each of the plurality of evaluation indices per unit quantity of each of measure draft items defining the measure draft, and
wherein the processor is configured to calculate, in the identification processing, values of the measure draft items based on values of the plurality of evaluation indices that are included in the overlap range, and on the values of each of the plurality of evaluation indices per unit quantity of each of the measure draft items, and identify the calculated values of the measure draft items as the measure draft.

8. The consensus building support device according to claim 7,
wherein the consensus building support device has access to a measure candidate database configured to store values of the measure draft items as measure candidates, and
wherein the processor is configured to calculate, in the identification processing, values of the plurality of evaluation indices based on the values of each of the plurality of evaluation indices per unit quantity of each of the measure draft items and on the values of the measure draft items, and when the calculated values of the plurality of evaluation indices are included in the overlap range, identify the values of the measure draft items as the measure draft.

9. The consensus building support device according to claim 8,
wherein the measure candidate database is configured to store a value of each of the measure draft items in association with an attribute of the measure candidates, and
wherein the processor is configured to calculate, in the identification processing, the values of the plurality of evaluation indices based on the values of each of the plurality of evaluation indices per unit quantity of each of the measure draft items and on a value of each of the measure draft items that is associated with a specific attribute, and, when the calculated values of the plurality of evaluation indices are included in the overlap range, identify the values of the measure draft items as the measure draft.

10. The consensus building support device according to claim 9, wherein the specific attribute is information indicating that the value of the associated measure draft item is input data that is input by another of the plurality of users.

11. The consensus building support device according to claim 9, wherein the specific attribute is information indicating that the value of the associated measure draft item is a value in a measure carried out in a past.

12. The consensus building support device according to claim 9, wherein the specific attribute is information indicating that the value of the associated measure draft item is a value obtained through simulation.

13. The consensus building support device according to claim 1,
wherein the consensus building support device has access to an evaluation index value table configured to store values of each of the plurality of evaluation indices per unit quantity of each of measure draft items defining the measure draft, and a measure candidate database configured to store values of the measure draft items as measure candidates,
wherein the processor is configured to acquire, in the acquisition processing, a priority order that is set for each of the plurality of evaluation indices by one of the plurality of users, and a numerical value range of each of the plurality of evaluation indices,
wherein the processor is configured to select a specific evaluation index from the plurality of evaluation indices in accordance with the priority order that is set for each of the plurality of evaluation indices by the one of the plurality of users and that is acquired through the acquisition processing, calculate, for each of the measure candidates, a value of the specific evaluation index based on values of the measure draft items and on values of each of the plurality of evaluation indices per unit quantity of each of the measure draft items, and execute search processing of searching for the number of measure candidates in which the calculated value is included in a numerical value range that is set for the specific evaluation index by the one of the plurality of users, and
wherein the processor is configured to output, in the output processing, a search result obtained through the search processing.

14. The consensus building support device according to claim 1,
wherein the consensus building support device stores a correlation table including correlation coefficients about correlation between different evaluation indices,
wherein the processor is configured to acquire, in the acquisition processing, a value of and a change amount of a first evaluation index,
wherein the processor is configured to execute calculation processing of calculating, based on the value and change amount of the first evaluation index that are acquired through the acquisition processing, and on one of the correlation coefficients in the correlation table that is about correlation between the first evaluation index and a second evaluation index, a change amount of the second evaluation index, and
wherein the processor is configured to output, in the output processing, the change amount of the second evaluation index that is calculated through the calculation processing.

15. A consensus building support method, which is executed by a consensus building support device comprising a processor configured to execute a program, and a storage device configured to store the program,
the consensus building support method comprising executing, by the processor:
acquisition processing of acquiring, for each of a plurality of evaluation indices with which a measure draft is evaluated, a numerical value range that is set for the evaluation index by each of a plurality of users;
identification processing of identifying an overlap range in which a plurality of numerical value ranges that are each the numerical value range acquired for each of the plurality of evaluation indices through the acquisition processing overlap; and
output processing of outputting the overlap range identified through the identification processing.
